(19) United States
(12) Patent Application Publication
(10) Pub. No.: US 2026/0095110 A1
(43) Pub. Date: Apr. 2, 2026

(54) ALL-LIQUID TRIBOELECTRIC NANOGENERATOR FOR HARVESTING DISTRIBUTED ENERGY

(71) Applicants: THE UNIVERSITY OF HONG KONG, Hong Kong (CN); ADVANCED BIOMEDICAL INSTRUMENTATION CENTRE LIMITED, Hong Kong (CN)

(72) Inventors: Ruotong ZHANG, Hong Kong (CN); Ho Cheung SHUM, Hong Kong (CN); Haisong LIN, Hong Kong (CN)

(21) Appl. No.: 19/111,624

(22) PCT Filed: Sep. 20, 2023
(86) PCT No.: PCT/CN2023/120087

§ 371 Date: Mar. 13, 2025

Related U.S. Application Data
(60) Provisional application No. 63/376,915, filed on Sep. 23, 2022.

(51) Int. Cl. H02N 1/04

(52) U.S. Cl. CPC H02N 1/04

(57) ABSTRACT

The subject invention pertains to a comprehensive investigation of leading mechanisms of contact electrification in various liquid-liquid systems and an all-liquid TENG with optimized materials and structures to harvest energy from rainwater. Embodiments of the provided all-liquid TENG can generate a high charge density (e.g., 3.63 μC/L) with high output stability (e.g., crest factor≈1.1) and long effective contact electrification time. In certain embodiments, based on the direct current characteristics, energy harvested from rainwater can be fed directly to electronic devices and a self-powered rainfall sensor can also be implemented. Embodiments of the subject invention provide all-liquid systems useful in applications including distributed green energy, passive sensors, and other self-powered devices.

### CROSS-REFERENCE TO RELATED APPLICATION

The present application claims the benefit of U.S. Provisional Application Ser. No. 63/376,915, filed Sep. 23, 2022, which is hereby incorporated by reference herein in its entirety, including any figures, tables, or drawings.

### BACKGROUND OF THE INVENTION

As one of the most widely distributed water resources, rainwater contains tremendous energy that has not been effectively utilized so far. Triboelectric nanogenerators (TENG) represent a distributed method to convert trivial mechanical energy into electricity based on contact electrification. Benefitting from the large and replenishable contact interfaces in liquid-liquid systems, all-liquid TENG further promises efficient charge transfer. However, the limited understanding of liquid-liquid contact electrification has restricted its development.

### BRIEF SUMMARY OF THE INVENTION

Embodiments of the subject invention provide means for comprehensive investigation of leading mechanisms of contact electrification in various liquid-liquid systems and also an all-liquid TENG with optimized materials and structures to harvest energy from purified water, including but not limited to rainwater. Embodiments of the provided all-liquid TENG can generate a high charge density (e.g., 3.63 μC/L) with high output stability (e.g., crest factor≈1.1) and long effective contact electrification time. In certain embodiments, based on the direct current characteristics, energy harvested from rainwater can be fed directly to electronic devices and a self-powered rainfall sensor can also be implemented. Embodiments of the subject invention provide all-liquid systems useful in applications including distributed green energy, passive sensors, and other self-powered devices.

### BRIEF DESCRIPTION OF THE DRAWINGS

FIG. 1 Illustrates an all-liquid TENG system for rainwater-based energy harvesting according to an embodiment of the subject invention. a) Schematic illustration of the usage of a provided all-liquid TENG system. i) The generated rainwater droplet can rise spontaneously, facilitating electron transfer to produce a positively charged water droplet in HFE. ii) Electrostatic induction of the positively charged water droplet can generate displacement current between electrode ring and ground. b) Three states of the water droplet in all-liquid TENG, including i) generating, ii) approaching, and iii) moving away. c) Periodic short-circuit current I_{SC} generated during three states of water droplet. d) Comparison of one embodiment of the subject invention with related art all-liquid TENG [23, 26] systems in terms of charge density, effective CE time, and output stability.

FIG. 2 Investigation of L-L CE mechanism in various L-L systems according to various embodiments of the subject invention. a) Illustration showing three existing theories for L-L CE, including group dissociation, preferential ion adsorption, and electron transfer, in which the original dissociable group, free ions and electroneutral molecule before L-L CE will form dissociated group with dissociated ion, adsorbed anion, and transferred electron with adsorbed cation after L-L CE, respectively. b) Graph of charge variation of oil/water layer in L-L CE, revealing the transfer of positive and negative charges at the L-L interface caused by L-L CE. For each L-L system, at least three bottles of oil-water mixtures are prepared, as shown in FIG. 6A, while at least twenty samples were extracted from each bottle for charge measurements to obtain the mean value of each bottle, which appears as one dot in (b). The mean and standard deviation of all samples from different bottles for each L-L system appears as the bar and error bar in (b).c) Graph showing pH variation after forming O/W emulsions, revealing the variation of free OH⁻ and H⁺ in water phase. For each L-L system, at least four O/W emulsion samples were prepared, while each sample was measured at least twenty times to obtain the mean value of each sample, which appears as one dot in (c). The mean and standard deviation of all test results for different samples appears as the bar and error bar in (c). d) Graph showing calculated H⁺ concentration increase in emulsions and transferred charge between oil-water layers. e) Graph showing relationship between ζ-potential of Hex, HFE, and OA emulsions and HCl/NaCl concentration, revealing the co-existing mechanisms in L-L CE. f) Illustrated summary of dominant mechanisms and co-existing mechanisms in HFE-water, Hex-water, and OA-water systems, respectively. g) Graph showing effect of H⁺ ions on ζ-potential of Hex, HFE, and OA emulsions, represented by the difference between ζ-potential of emulsion with HCl and emulsion with the same amount of NaCl.

FIG. 3 Evaluation of key design parameters in rainwater-based all-liquid TENG according to embodiments of the subject invention. a) Schematic model of the all-liquid TENG system, used for calculating the induced charge on electrode ring and the corresponding short-circuit current. b) COMSOL simulation of the electric field during droplet's movement in the all-liquid TENG for calculating short-circuit current. c) Graph showing comparison of short-circuit current during droplet movement process calculated from the schematic model and that from simulation. d) Graph showing ratio of transferred charges in L-L CE between rainwater mimic (5×10⁻⁶ M HCl solution) and HFE, Hex and OA, respectively. e) Graph showing ratio of transferred charges in L-L CE at different contact distances. f) Graph showing ratio of transferred charges in L-L CE at different salt concentrations in water. g) Graph showing short-circuit current output using the optimized set-up parameters. h) Graph showing generated charge in all-liquid TENG, calculated through short-circuit current.

FIG. 4 DC all-liquid TENG for energy storage and load driving according to an embodiment of the subject invention. a) Alternating current generated in conventional related art TENG. b) Typical related art circuits for utilizing the alternating current generated by TENG, in which a rectifier will be required. c) Direct current generated in an exemplary and non limiting embodiment of all-liquid TENG with low crest factor according to the subject invention. d) Circuit for utilizing the direct current generated in this exemplary and non-limiting embodiment, in which a rectifier is not required, showing advantages in reducing switching energy loss and miniaturizing devices. e) Schematic capacitor model of and embodiment of the all-liquid TENG. f) Graph of open-circuit voltage output, increasing with energy generation process. g) Graph of voltage of the capacitor (1 μf) during the energy storage process, including quick charge process and linear charge process. h) Graph and related images illustrating lighting up an LED with the energy stored in the capacitor.

FIG. 5 Illustrates an application of rainwater-based all-liquid TENG with a self-powered sensor according to an embodiment of the subject invention. a) Graph showing variation of open-circuit voltage with time at changing flow rates. Inset shows the linear relationship between open-circuit voltage and total rainfall. b) Graph showing variation of short-circuit current with time at changing flow rates. Inset shows the linear relationship between open-circuit voltage and real-time flow rate. c) Image of an all-liquid TENG based-passive rainfall sensor and alarm system according to an embodiment of the subject invention, illustrating an outdoor setting (scale bar: 30 mm). d) Demonstration of an automated all-liquid TENG-based rainfall alarming system, which can monitor the total rainfall based on the generated open-circuit voltage, displaying the total rainfall on the LCD screen when it is beneath the warning line and warning the excessive rainfall when it is above the warning line.

FIGS. 6A-6D Illustrate a process of quantifying the amount of charge variation in L-L CE according to an embodiment of the subject invention. (6A) Preparation of liquid samples after L-L CE, by rotating emulsions of HFE-water, Hex-water, and OA-water to separate two liquids under centrifuge force. (6B) Photos of separated oil layer and water layer after subtracting background, including i) oil layer in HFE-water system, ii) water layer in HFE-water system, iii) oil layer in Hex-water system, iv) water layer in Hex-water system, v) oil layer in OA-water system, and vi) water layer in OA-water system (Scale bar: 100 μm). (6C) Graph of average charge of water layer and HFE layer before L-L CE and after L-L CE (0.8 ml sample). For each L-L system, at least three bottles of oil-water mixtures were prepared, while at least twenty samples were extracted from each bottle for charge measurements. FIG. 6D shows the relationships between 6A-6C.

FIG. 7 Illustrates measurement of charge density near the L-L interface according to an embodiment of the subject invention. (a) Pumping out liquid samples droplet by droplet to measure the accumulated charge of all the fallen droplets, in (b) HFE and water system, (c) hexadecane and water system, and (d) oleic acid and water system. The measured charge value within 30 seconds before and after the liquid-liquid interface was differentiated (or varying-step differentiated when data was stepwise) and smooth to obtain the result of “charge density-time”. By defining the starting/ending point of the effective data as −50% and 50%, respectively, (e) the charge distribution near the oil-water interface is obtained, indicated by the variation tendency of charge density around the interface (x=0%). A positive trend toward the interface means the liquid becomes more positively charged near the L-L interface, and vice versa.

FIG. 8 Is a graph showing a comparison of structural influence of contact distance to the short-circuit current and the influence of contact distance to transferred charge in L-L CE process, showing the positively related relationship of contact distance with L-L CE and the negatively related relationship of contact distance with short-circuit current according to an embodiment of the subject invention.

FIG. 9 Illustrates an equivalent circuit model according to an embodiment of the subject invention. The output voltage V is given as [57, 59]:

$$V = - \frac{Q}{C} + {V}_{OC} ,$$

where is the transferred charge form the primary electrode to the reference electrode. Since the output voltage equals 0 at the short circuit condition, the short-circuit charge Q_{SC} can be obtained as: Q_{SC}=V_{OC}·C, where C is approximately a constant (C₀) during the working process because the electrode of all-liquid TENG is fixed [56]. Therefore, the short-circuit current can be written as:

$${I}_{SC} = \frac{{d V}_{o c} \cdot {C}_{0}}{d t} .$$

FIG. 10 Is a graph illustrating the average charge of DI water samples added by different droppers/pipettes according to an embodiment of the subject invention.

FIG. 11 Is a chart showing a data process of

$$\frac{δ q}{{q}_{0}}$$

to obtain the value of k in Eq. (4) according to an embodiment of the subject invention. Unified current is firstly obtained from

$$\frac{{I}_{SC}}{{I}_{0}} ,$$

and k equals to the approaching value of the unified current peak value

$$\frac{Δ {I}_{PEAK}}{{I}_{0}} .$$

FIG. 12 Illustrates sequential photographs of the droplet generation and rising process from both side view and top view (water droplet is dyed with methylene blue) according to an embodiment of the subject invention, indicating no direct contact between the droplet and the electrode ring.

FIG. 13 Illustrates two different all-liquid TENG systems for water-based energy harvesting, each according to an embodiment of the subject invention. In panel (a) the generated rainwater droplet can rise spontaneously under the force of gravity when the density of the oil is greater than the density of the water. In panel (b) the generated rainwater droplet can fall spontaneously under the force of gravity when the density of the oil is less than the density of the water. This can be used as an experimental setup for measuring the ratio of transferred charges in L-L CE between rainwater and (a) HFE, (b) Hex and OA, respectively. For certain HFE-water based L-L TENG embodiments, droplets are generated from the outlet at the bottom of the HFE and rise through the electrode by buoyancy. For certain Hex-water and OA-water based L-L TENG embodiments, since the densities of Hex and OA are lower than water, droplets are generated from the outlet at the top of the Hex or OA and fall due to gravity. By controlling the relative distance between the outlet and the electrode ring to be the same, the CE process and electrostatic induction process that took place in these two setups are the same.

FIG. 14 Illustrates the relationship between the generated current (I_{SC}) and the velocity at which friction occurs, according to an embodiment of the subject invention, including the velocity at which the droplets expand during generation process (V_{g}) and the velocity at which the droplets rise (Vᵣ). a) The generated short-circuit current I_{SC} is composed of two parts: I_{SC_g} produced by droplet generation and I_{SC_r} produced by droplet rise, which is affected by V_{g} and Vᵣ, respectively. b) Experimental results showing the correlation between I_{SC} and V_{g}. The measured I_{SC} is overall positively related to V_{g}, consistent with the relationship between velocity and energy produced in most other TENG devices. The inset shows the linear relationship between I_{SC_g} and V_{g}. c) Theoretical data of the generated I_{SC_r} under different Vᵣ, indicating that the magnitude of the generated current wave increases with Vᵣ, but the generated current is more sensitive to changes in V_{g} than to changes in Vᵣ.

FIG. 15 Illustrates the pA-level current measurement by using Keithley 6514 electrometer, according to an embodiment of the subject invention. a) Schematic diagram of the experimental setup. L-L TENG is covered by a Faraday cage for electrostatic shielding, while the electrometer is set at pA-level current measurement. b) The practical current noise is measured to be around fA-level, satisfying the requirements for pA-level current measurement.

### DETAILED DISCLOSURE OF THE INVENTION

Green energy for sustainable development can be achieved by converting environmental energy into electricity [1-3]. The traditional approach is to harvest large-scale energy by electromagnetic generators and then transmit it through the centralized power grids, as in the case of wind power stations or hydroelectric power plants [4, 5]. However, the requirements of large-scale energy for driving the bulky electromagnetic generators, losses from long-range power transmission, and fixed-location grid facilities have restricted its flexibility and the type of energy that can be efficiently utilized [6]. By contrast, the direct-to-consumer nanogenerators with widely distributed energy sources, such as rain or mild vibration in nature, offer a new perspective for flexible self-powered equipment and areas beyond the coverage of power grids [7, 8]. Among them, triboelectric nanogenerators (TENG) based on contact electrification (CE) provide one of the most flexible, cost-effective, and cleanest options [9]. By establishing an interfacial electrostatic field through CE, the tiny mechanical motion of friction layers can generate a Maxwell displacement current in TENG [10-12].

By virtue of the compact and replenishable contact interfaces between liquid and liquid, all-liquid TENG can easily adopt a large effective contact area and remove surface defects by inducing liquid flows, promising efficient charge transfer in CE process [13, 14]. Various hypotheses have been proposed to explain the mechanism of CE in liquid-liquid (L-L) systems. For example, hydroxide ions are claimed to preferentially adsorb on the L-L interface, causing the pH dependence of oil-in-water (O/W) emulsions' ζ-potential [15-19]. For oil with dissociable groups, functional group dissociation is regarded as a controllable method for self-charging and stabilizing the oil-water interface [20, 21]. Recently, simulations and experiments also suggest that electrons can transfer across the hydrophobic L-L interface, leading to the negative ζ-potential of O/W emulsions [22-25]. However, these theories are all proposed after studying context-specific phenomena or individual L-L systems. The lack of a comprehensive investigation in various systems has therefore limited the understanding of their respective requisite conditions and compatibility in different systems. Therefore, in the few existing studies of all-liquid TENG, the choice of material and structure is not systematically guided, consequently limiting the control over the generated charge density, effective CE time, and output stability. [23, 26].

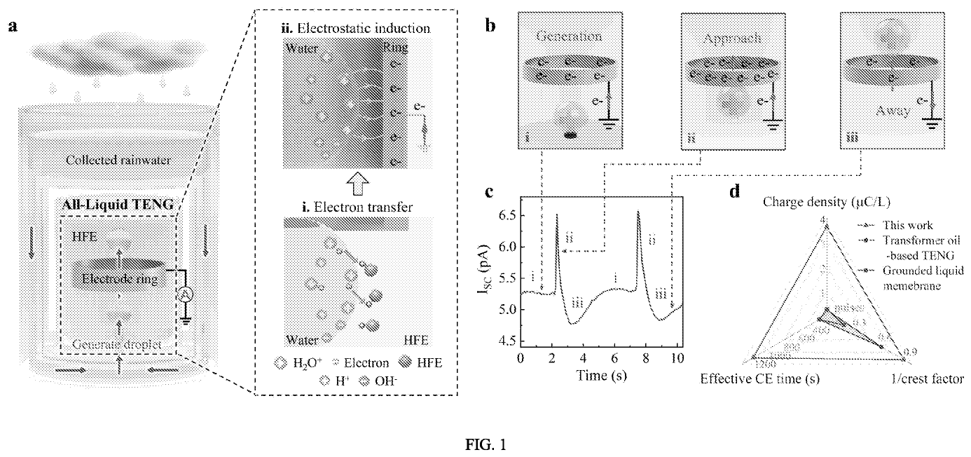

Embodiments of the subject invention permit systematical investigation L-L CE in different all-liquid systems by studying the charge, pH, and ζ-potential variations, and reveal their respective dominant L-L CE mechanisms with co-existing mechanisms. Embodiments provide novel, all-liquid TENG with preferred materials and structures to harvest energy from rainwater (FIG. 1a, wherein the density of the oil is higher that the density of the water). HFE is selected as frictional oil material to positively charge the collected rainwater droplet through electron transfer (FIG. 1ai), while a ring-shaped electrode is designed to generate displacement current through electrostatic induction (FIG. 1aii). Due to the fluidity of the liquid friction layer, the contact surface can be refreshed continuously. Therefore, each water droplet can gradually become more positively charged due to the loss of electrons, generating displacement current periodically. In the droplet generation process (FIG. 1bi), the short-circuit current I_{SC} substantially functions as a positive constant (FIG. 1c). In the droplet movement process, when the positively charged droplet approaches the electrode ring (FIG. 1bii), electrons are attracted to the electrode ring from the ground and produce a positive current peak in I_{SC}. Similarly, the departure of the positively charged droplet away from the electrode causes electrons to move in the opposite direction (FIG. 1bii), thus generating a reverse peak in I_{SC}.

Advantageously employing a proper frictional material selection and structural design, provided embodiments of all-liquid TENG show advantages in high charge density (3.63 μC/L), long effective CE time (1200 s) and high output stability (1/crest factor≈0.9, defined as the ratio of the root mean square value to the peak value) (FIG. 1d) [23, 26]. Because of the direct current characteristics of the generated current, provided embodiments of all-liquid TENG can also drive loads without rectifiers, avoiding the additional energy loss in switching devices and facilitating the device miniaturization [9, 27]. In addition, its electrical output shows a linear relationship with the rainfall capacity, thus demonstrating the function of passive sensing. With the demonstrated capabilities of energy harvesting and self-powered sensing, provided embodiments of the all-liquid TENG are useful in constructing a distributed green energy network and facilitating the development of self-powered devices in terms of miniaturization and flexibility.

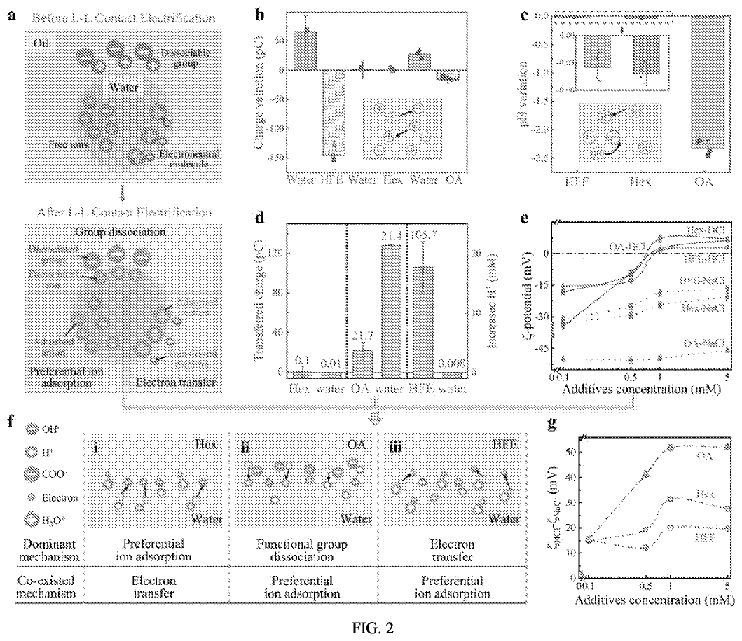

Embodiments of the subject invention identify mechanisms of CE in different all-liquid systems. In related art studies of L-L CE, several phenomena have been found at the oil-water interface (FIG. 2a): dissociable functional group in oil can dissociate into two parts with opposite charge polarities [20, 21]; free OH⁻ ions in water phase can preferentially adsorb on the hydrophobic interface [15-19]; electrons can also transfer from electroneutral water molecule to oil, forming cations in the water phase and transferred electrons in the oil phase [22-25]. However, their respective required conditions in various systems are yet to be identified, making it difficult to tell whether multiple mechanisms may co-exist, and thus limiting the design and optimizations of all-liquid TENG [23, 24]. To address this issue, embodiments of the subject invention provide hydrofluoroether fluid HFE 7500 (HFE)-water, hexadecane (Hex)-water, and oleic acid (OA)-water systems as typical examples to systematically investigate their existing mechanisms of L-L CE by comparing their charge, pH, and ζ-potentials.

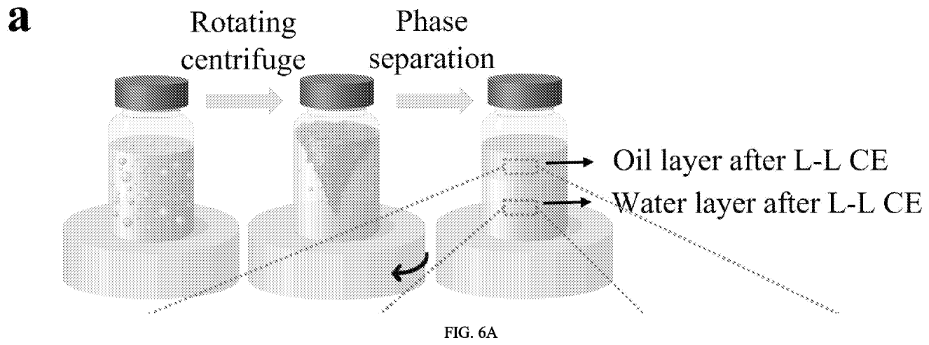

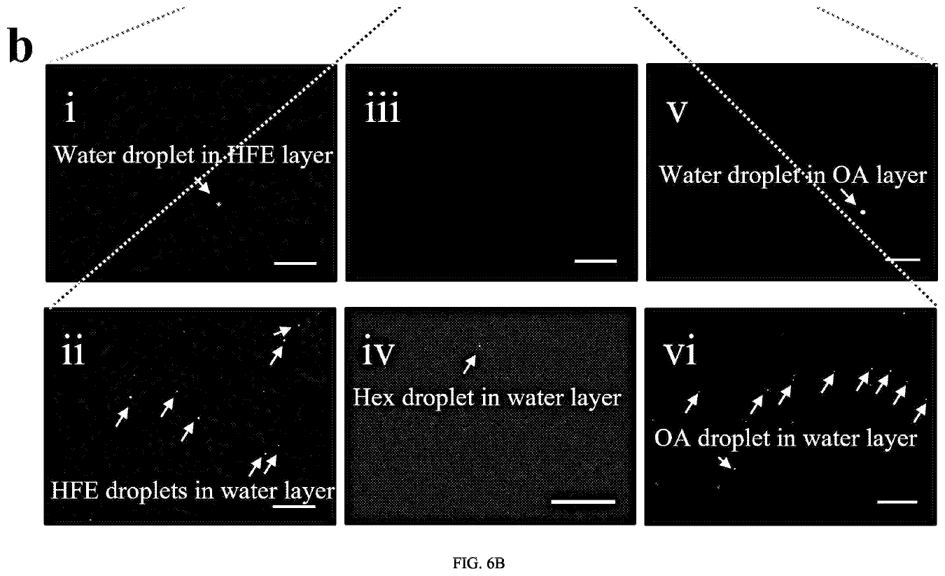

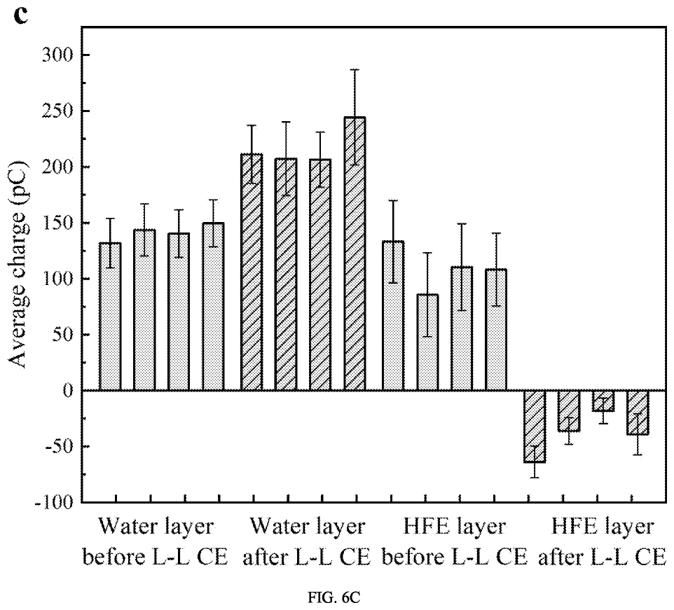

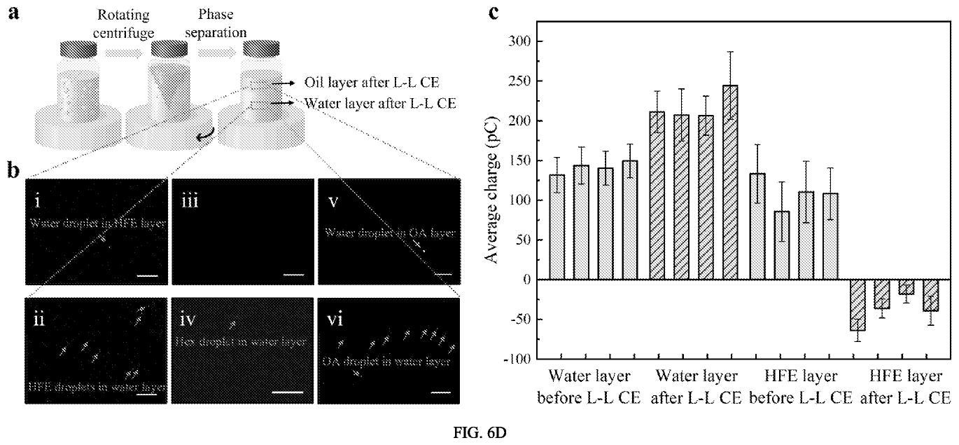

Charge variation of each oil/water phase caused by L-L CE is first measured to indicate the amount of transferred charges across the L-L interface. By measuring the static charges possessed by pure oil/water before L-L CE and the corresponding samples after L-L CE respectively (FIG. 6), charge variation caused by L-L CE can be calculated (FIG. 2b). In HFE-water and OA-water systems, both water phases obtain positive charges and oil phases obtain negative charges after L-L CE. As for the Hex-water system, no obvious charge variation is measured for both phases.

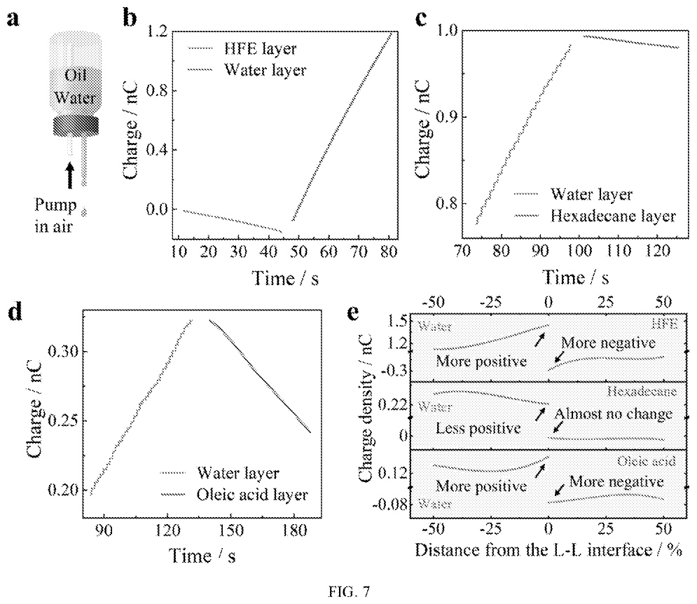

Embodiments also measure the variation of pH values when 10% O/W emulsions are formed to reveal the change of free H⁺/OH⁻ (FIG. 2c). In HFE and Hex emulsions, pH values only approximately decrease by 0.04 compared with DI water; while pH value decreases by 2.3 in OA emulsions, much larger than the other two systems. By comparing the increase of free H⁺ concentration in emulsions calculated based on FIG. 2c and the average transferred charges between oil-water layers calculated based on FIG. 2b, embodiments can advantageously account for what causes the charge variation directly (FIG. 2d). In the Hex-water system, the concentration of H⁺ slightly increases by 0.01 mM in emulsions. Since no significant charge transfer is observed between bulk oil/water phases, this variation of free H⁺ can be explained by the preferential adsorption of OH⁻ on the L-L interface (FIG. 2a) [15-18, 28]: Formation of emulsions will increase the L-L interface areas, and the adsorbed OH⁻ on the interface will increase accordingly. Therefore, the increasingly adsorbed OH⁻ will slightly release extra free H⁺ in the water phase without transferring charges across the L-L interface. This inference can be further supported by charge distributions near the L-L interface, where the charge density of the water layer becomes less positive when approaching the L-L interface, while no charge density variation can be seen in the Hex layer (FIG. 7). As for the OA-water system, H⁺ concentration increases sharply after forming OA emulsions, while distinct charge transfer is also observed between two phases. Considering OA (C₁₇H₃₃COOH) contains a dissociable hydrophilic carboxyl group, these results fit with the theory of group dissociation, as shown in FIG. 2a: The COOH will dissociate with water to form dissociated H⁺ in the water phase and COO⁻ in the oil phase [21, 29, 30], increasing both H⁺ concentration and positive charges in water phase. Regarding the HFE-water system, although significant charge transfer between two immiscible layers is also observed, the variation of H⁺ concentration in HFE emulsions is very weak. This means the charge transfer is not dominated by the H⁺/OH⁻ ion transfer, but by electron transfer (FIG. 2a). Because of the strong negativity of the fluorine element in HFE (C₉H₅F₁₅O), electrons tend to transfer from water to HFE [13, 31-33], generating a positively charged water layer and a negatively charged HFE layer after L-L CE. Charge distributions near the OA-water and HFE-water interfaces can also support the above inferences (FIG. 7). The magnitude of charge density increases in both oil and water layers when approaching the interface because both of their dominant mechanisms will produce positive and negative charges on respective sides of the interface, and coulombic attraction will accumulate charges at the interface.

Based on the discussed dominant mechanisms in Hex-water, OA-water, and HFE-water systems respectively, most charge- and pH-related phenomena can be well explained. However, the “electron transfer” mechanism alone still cannot explain the slight increase of H⁺ during the formation of HFE/water emulsions. To further investigate the mechanisms of L-L CE, embodiments measure the ζ-potential of three 1% O/W emulsions (Hex, OA, and HFE) with various concentrations of NaCl or HCl, respectively (FIG. 2e). The signature trends of ζ-potential vary with different mechanisms; hence embodiments can identify the dominant, or jointly existing mechanisms in different systems.

As for Hex emulsions without additives, the preferential adsorption of OH⁻ on the interface leads to a negative ζ-potential [15, 16, 28]. With the addition of NaCl, the magnitude of the negative ζ-potential decreases because the increased ionic strength will compress the electrical double layer [17, 34, 35]. However, the negative ζ-potential is converted into a positive value with rising HCl concentration. This is because the H⁺ ions brought by HCl will neutralize the OH⁻ adsorbed on the L-L interface [36]. When the concentration of H⁺ exceeds a threshold value, the OH⁻ is depleted and H⁺ accumulates along the interface instead, leading to a positive ζ-potential [37, 38]. The measured isoelectric point is between pH 3.3 and 3, implying that OH⁻ is adsorbed at the Hex-water interface at least 10^{7.4} times more favorably than the H⁺[15]. Besides, spectral shifts and molecular dynamics simulations in other research have also proved electron transfer through C—H . . . O hydrogen bonds in the Hex-water system. Considering the electron transfer can only produce about −0.015 e/nm² surface charge densities at the interface [22], it can be too minute to be observed in the experiments above, indicating possible co-existing mechanisms in the Hex-water system.

In the OA-water system, a negative ζ-potential is produced by the carboxyl group dissociation. With the rise of NaCl concentration, the magnitude of the negative ζ-potential firstly increases and then decreases due to the competition between the salt effect and compression of the electrical double layer [39]. When HCl is added to OA emulsions instead, the magnitude of the negative ζ-potential decreases since the introduction of H⁺ in solution would impede the dissociation of the carboxyl group [40, 41]. However, the ζ-potential reaches a positive value when H⁺ concentration exceeds 1 mM. As the carboxyl group dissociation can only produce a negative ζ-potential, this variation indicates that hydroxyl ions also preferentially adsorb onto the OA-water interface [42, 43]. Due to its insignificant contribution compared with group dissociation, the preferential ion adsorption can in certain embodiments be neglected in previous charge/pH measurements (see, e.g., Example S1). Therefore, in addition to the dominant group dissociation, a co-existing mechanism of preferential ion adsorption likely also exists in the OA-water system.

Regarding the HFE-water system, electron transfer causes a negative ζ-potential of O/W emulsions. By adding NaCl, the magnitude of the negative ζ-potential decreases as the increasing salt concentration will hinder electron transfer, similar to the variation in solid-liquid contact electrification [44-46]. When HCl is added to HFE emulsions instead, the negative ζ-potential is converted into a positive value when H⁺ concentration exceeds 1 mM. This trend is similar to that in OA emulsions, indicating the co-existed preferential adsorption of ions on the interface. This analysis also accords with the previous result that H⁺ increases slightly when HFE emulsion is formed (FIG. 2d).

Embodiments of the subject invention are reflected in FIG. 2f. In the Hex-water system, the dominant L-L CE mechanism is preferential ion adsorption, while the mechanism of electron transfer is also at play. As for the OA-water system, functional group dissociation dominates while preferential ion adsorption also co-exists. Similarly, in HFE-water system, preferential ion adsorption also exists simultaneously in addition to the dominant electron transfer. This conclusion can be further supported by quantifying ζ_{HCl}−ζ_{NaCl}, while the larger ζ_{HCl}−ζ_{NaCl} will indicate a larger effect of H⁺ on L-L CE (FIG. 2g). The OA-water system can be influenced by H⁺ the most among the three L-L systems since H⁺ affects both group dissociation and preferential adsorption of OH⁻. The HFE-water system is influenced by H⁺ the least among the three systems because H⁺ only affects the preferential adsorption of OH⁻, while the dominant electron transfer will not be affected. The result in FIG. 2g therefore agrees with conclusions above.

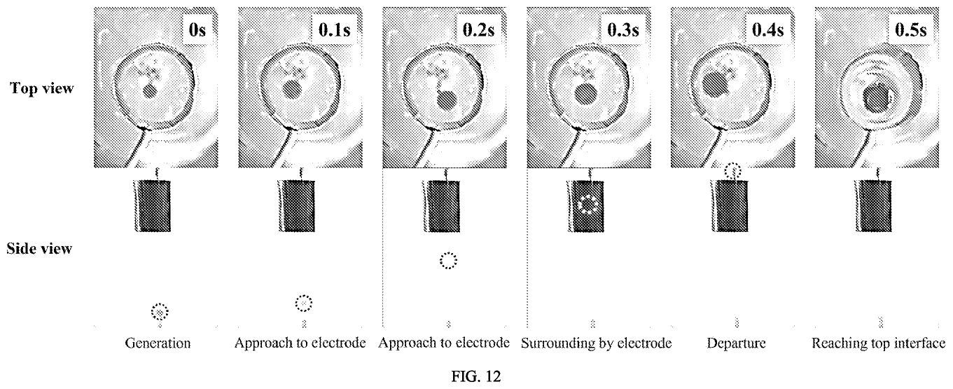

Based on the above understanding, the favorable mechanism for application scenario can be targeted by optimizing materials. Here, considering rainwater is usually weakly acidic [47, 48], L-L CE in the rainwater-based TENG can be impeded by the increasing H⁺ the least. Therefore, HFE can be one of the appropriate frictional materials to effectively charge the collected rainwater, and electron transfer will therefore dominate in the all-liquid TENG along with co-existing preferential ion adsorption. Since the extra adsorbed hydroxyl ions at the interface can impede the charge conduction through direct contact, the structure of all-liquid TENG is designed as a non-contact mode with a ring-shaped electrode. In this way, water droplets can rise through the electrode ring without contact (FIG. 12), and displacement current can be generated through long-range electrostatic induction, as shown in FIG. 1aii.

Embodiments of the subject invention provide advantageous designs of a rainwater-based all-liquid TENG. Based on the above investigation of L-L CE mechanisms, HFE and non-contact structure are selected as advantageous material and structure, respectively, for an embodiment of a rainwater-based all-liquid TENG. To further optimize the system, the influence of different design parameters, including frictional material, contact distance, and salt concentration, on L-L CE during all-liquid TENG's working process can be quantified, as follows.

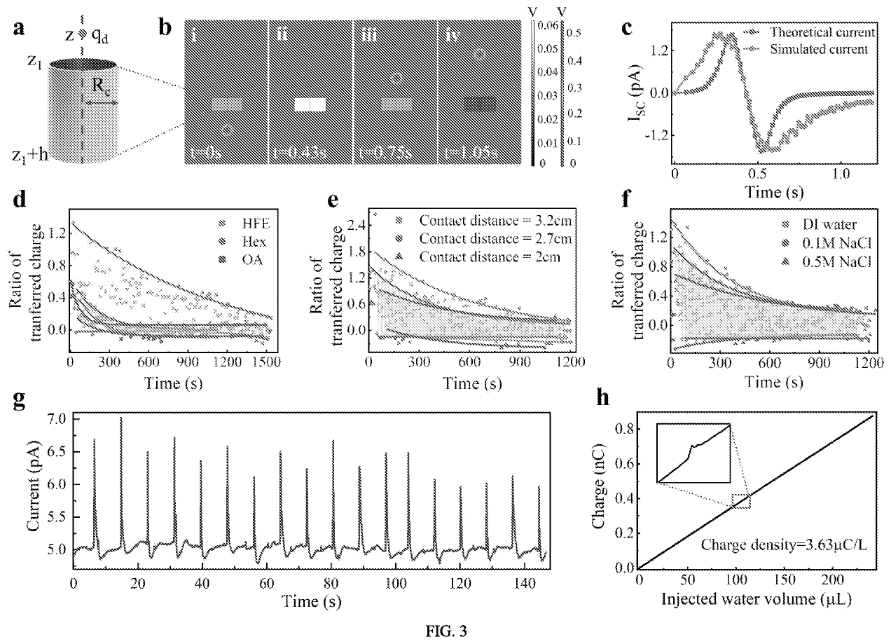

A theoretical model is first established to depict the relationship between the short-circuit current I_{SC} and the charge of rainwater droplet. Based on this model, we can calculate the amount of extra charge gained by each droplet in TENG and quantitively compare the performance of different parameters in charging rainwater. In the schematic model (FIG. 3a), the water droplet is assumed as a point charge that moves on the central axis of the electrode ring. When either the static charge amount or the relative position of the water droplet changes, the induced charge on the electrode ring changes correspondingly. Consequently, the short-circuit current produced by the directional movement of induced charges is written as:

$${I}_{SC} = \frac{d {q}_{c}}{d t} = \frac{d {q}_{d}}{2 dt} \cdot [ \frac{{z}_{1} + h - z}{\sqrt{{( {z}_{1} + h - z )}^{2} + {R}_{c}^{2}}} - \frac{{z}_{1} - z}{\sqrt{{( {z}_{1} - z )}^{2} + {R}_{c}^{2}}} ] + \frac{{q}_{d}}{2} \cdot \frac{d [ \frac{{z}_{1} + h - z}{\sqrt{{( {z}_{1} + h - z )}^{2} + {R}_{c}^{2}}} - \frac{{z}_{1} - z}{\sqrt{{( {z}_{1} - z )}^{2} + {R}_{c}^{2}}} ]}{d t} \qquad ( 1 )$$

where q_{c} is the induced charge on electrode ring [49], q_{d} is the charge possessed by the droplet, z and z₁ is the position of the water droplet and the closer edge of the electrode ring, h is the height of the electrode ring and R_{c} is the radius of the electrode ring. To prove the applicability of Eq. (1), we can simulate the electric field (FIG. 3b) and short-circuit current I_{SC} in the all-liquid TENG with COMSOL. By comparing the theoretically calculated and simulated I_{SC} during droplet movement in FIG. 3c, Eq. (1) is proved to be applicable for certain embodiments of the all-liquid TENG (see, e.g., Example S2).

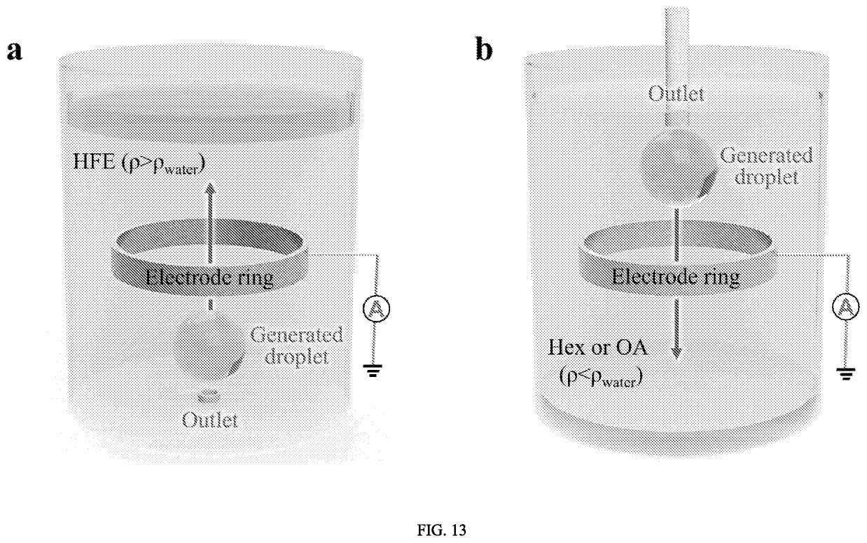

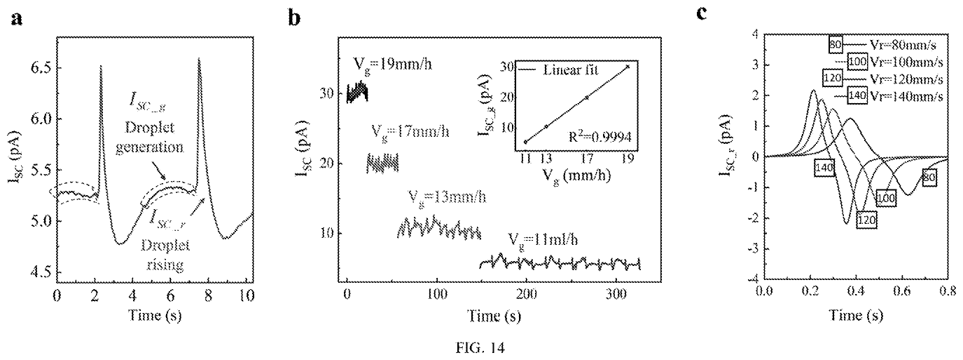

Based on Eq. (1), we can calculate the ratio of transferred charges in L-L CE to the original charge of water droplet by measuring I_{SC} (e.g., as detailed in Materials and Methods, below). Considering the function of frictional material in all-liquid TENG is to charge rainwater droplets, the ratio of transferred charges for each water droplet can quantitatively demonstrate the performance of frictional materials. HFE and other oils with different dominant mechanisms, including OA and Hex, can be advantageously applied as frictional materials in all-liquid TENG, respectively (FIG. 13). Under the condition of weakly acidic rainwater, I_{SC} in each all-liquid TENG is measured to calculate the ratio of transferred charges during all-liquid TENG's working process, as shown in FIG. 3d. The transferred charges in HFE are much larger than that in OA and Hex, indicating that HFE can charge the rainwater the most among these three materials. Therefore, HFE performs the best among these three materials for a rainwater collection-based all-liquid TENG, and the material selection is proved to be effective in this embodiment.

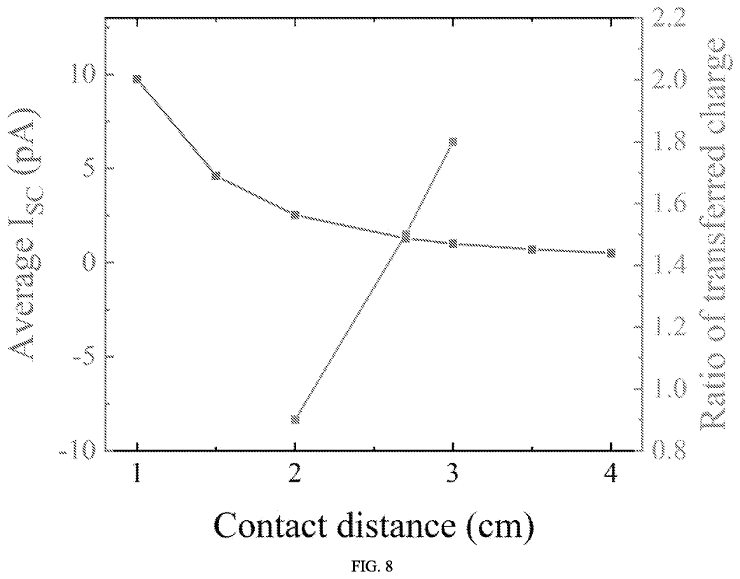

Besides frictional material selection, the effect of other parameters to L-L CE also need to be characterized in this way. All-liquid TENGs with various L-L contact distances are designed by setting the electrode ring at different distances from the outlet. The ratio of transferred charges in L-L CE is obtained from the measured I_{SC} (FIG. 3e). The transferred charge before triboelectric saturation (about 1200 s) increases with contact distance, indicating that water droplets can obtain more extra charges from HFE with a longer contact distance. Meanwhile, the contact distance also structurally affects the generated current I_{SC} but in an opposite manner (FIG. 8). In this embodiment, contact distance can be advantageously set at 2.7 cm in the designed rainwater-based all-liquid TENG to balance the positively related relationship with L-L CE and the negatively related relationship with I_{SC} Similarly, all-liquid TENGs with different ionic strengths are designed by adding various salt concentrations in water, and the ratio of transferred charges in L-L CE is also obtained (FIG. 3f). The result shows that higher ionic strength leads to less charge transfer in L-L CE, consistent with the previous ζ-potential result (FIG. 2e). Therefore, in the designed rainwater-based all-liquid TENG, no extra salt is required in the collected rainwater. With the optimized design parameters, the rainwater-based all-liquid TENG can generate displacement current continuously (FIG. 3g). The generated charge density is about 3.63 μC/L (FIG. 3h), which is higher than previously reported all-liquid TENGs due to the advantageously designed materials and structures[23, 26].

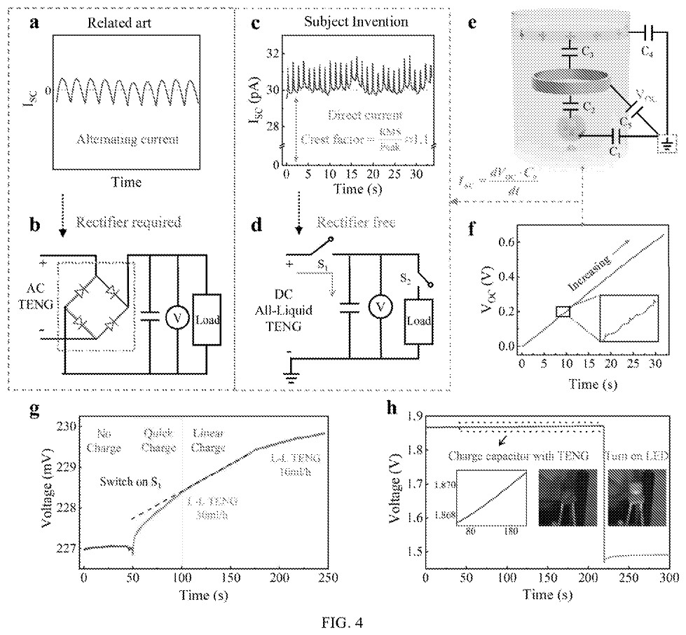

Embodiments provide a direct current all-liquid TENG for energy storage and load driving. Based on the optimized materials, structures, and other parameters, the provided rainwater-based all-liquid TENG has shown great potential in energy harvesting, which can subsequently be stored or utilized for driving loads. Considering most electronic devices need to be driven by direct current, for the conventional TENG which usually generates alternating current (FIG. 4a), a rectifier will be required to utilize the generated power on driving electronic loads (FIG. 4b) [9, 50], such as the full-wave rectifier, a rotary rectifier bridge [51], or a multiphase rotation-type structure [52]. The extra required intricate circuits will not only increase the energy loss on switching devices, but also reduce the integration and portability of devices [53, 54]. By contrast, embodiments of the subject invention provide an all-liquid TENG with the capability of generating a direct current with a relatively low crest factor (FIG. 4c). Therefore, embodiments provide a DC all-liquid TENG that can advantageously be directly connected with one or more energy storage units, direct-current devices, or other electronic loads without extra devices (FIG. 4d). The low crest factor further decreases the impact on electronic devices, in favor of extending the device's lifetime [26, 55].

To better illustrate why embodiments of the designed all-liquid TENG can generate a direct current, the system of all-liquid TENG is simplified as a capacitor model [56, 57], as shown in FIG. 4e. Capacitors C₁, C₂ . . . C₆ are formed between the water droplet, electrode ring (primary electrode), accumulated water layer, and ground. The open-circuit voltage V_{OC} can be written as:

$${V}_{O C} = {V}_{1} + {V}_{2} = {Q}_{droplet} ( t ) \cdot ( \frac{1}{{C}_{1}} - \frac{1}{{C}_{2}} ) \qquad ( 2 )$$

where Q_{droplet}(t) is a function of time, representing the total charge possessed by the water droplet. During the droplet generation process, Q_{droplet}(t) increases while C₁ and C₂ remain substantially as constants (see, e.g., Example S3), leading to a rising V_{OC}. When the droplet starts moving, C₂ increases first and then decreases while C₁ keeps almost constant (see, e.g., Example S3), producing a positive peak in the wave of V_{OC}.

Although it can appear in certain embodiments that droplets are added one by one as a discrete system, the process of droplet generation cab actually be continuous in throughout certain embodiments of the entire L-L TENG system because the outlet locates at the bottom of the HFE. During continuous droplet generation, V_{OC} grows continuously. Meanwhile, peaks of V_{OC} caused by discrete droplet rising events are distributed over the voltage profile.

After a first droplet rises and merges into the accumulated water layer, the charge of the droplet is accumulated in the upper water layer, inhibiting an abrupt change in V_{OC}. Then, a second droplet will repeat the process, while V_{OC} will continuously increase with discrete fluctuations in general (FIG. 4f).

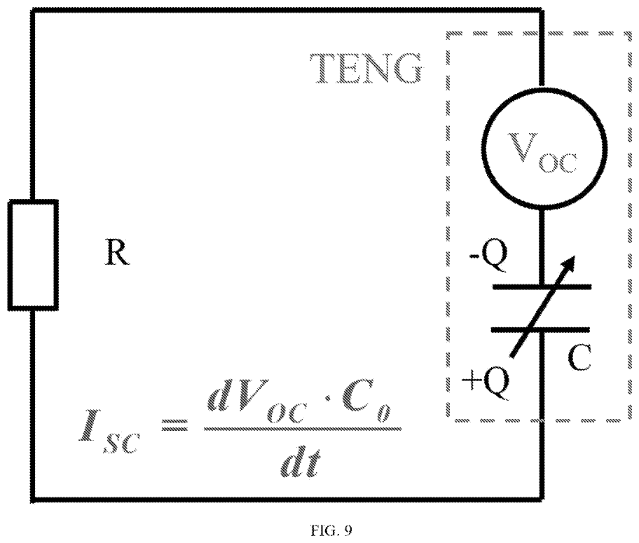

According to the equivalent circuit model in (FIG. 9), short-circuit current I_{SC} can be described as:

$${I}_{S C} = \frac{d {Q}_{SC}}{d t} = \frac{d {V}_{OC} \cdot {C}_{0}}{d t} \qquad ( 3 )$$

Based on the previous analysis of V_{OC}, I_{SC} can fluctuate towards positive and negative values sequentially during the droplet rising process, which forms the time-varying part of the current profile. During the continuous droplet generation process, I_{SC} remains as a positive direct current since V_{OC} increases, creating a continuous DC bias. With suitable design parameters in certain embodiments of the subject invention, the combination of these two parts of current can result in a time-varying current that is greater than zero overall, leading to a DC TENG according to embodiments of the subject invention.

To achieve energy storage and load driving, DC all-liquid TENG, capacitor, and load (e.g., an LED in certain embodiments) are connected in the way as shown in FIG. 4d. Initially, S₁ is switched off and charge is accumulated in the all-liquid TENG because of the continuous generation of water droplets. When V_{OC} of all-liquid TENG reaches to 2.1V, S₁ is switched on and all-liquid TENG starts to charge the capacitor. The charging process includes quick charge and linear charge (FIG. 4g). In the first stage, since charges have been accumulated in all-liquid TENG for a while, the charging velocity is larger and time non-linear. In the second stage, the charging process becomes time-linear, and its slope is positively related to the flow rate. The stored energy can also be released programmatically (e.g., as demonstrated in FIG. 4h). After the capacitor is charged, a LED can be lit up by switching on S₂. When S₂ is switched off again, the charging process of the capacitor is repeated until the voltage of the capacitor is high enough to lighten the LED again. In certain embodiments, the speed of energy storage can be further exponentially increased through parallel connection.

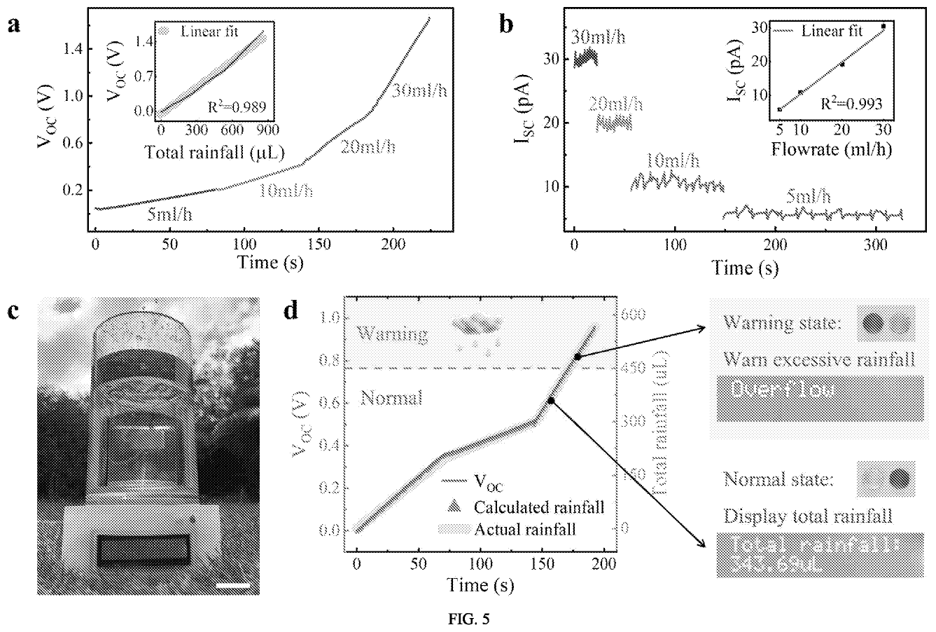

Embodiments of the subject invention provide rainwater-based all-liquid TENG for self-powered sensors. In addition to energy harvesting, the provided all-liquid TENG also exhibits potential as a self-powered sensor of rainfall capacity. According to Eq. (2), the open-circuit voltage V_{OC} is approximately proportional to Q_{droplet}(t) during the droplet generation process. Since during droplet generation will increase faster with the flow rate at water outlet, the increasing rate of V_{OC} can be positively related to the flow rate. Besides, V_{OC} is also proved to have a positive linear correlation with respect to the total rainfall, as shown in FIG. 5a. Similarly, due to Eq. (3), the overall short-circuit current I_{SC} can also increase with flow rate, while the average value of I_{SC} shows a clear linear relationship to the flow rate (FIG. 5b). Therefore, based on the generated open-circuit voltage or short-circuit current, embodiments of the provided all-liquid TENG can work as a passive sensor of rainfall capacity.

Embodiments provide an all-liquid TENG-based rainfall alarming system that can monitor the total rainfall or rainfall rate through an electrical output (FIG. 5c). By applying a reservoir to collect rainwater, rainwater droplets can be passively pumped out at the bottom of TENG due to hydrostatic pressure (see, e.g., Example S4). Based on the linear relationship between the open-circuit voltage and total rainfall, the value of total rainfall can be calculated and compared with the set warning line. When the total rainfall is still beneath the warning line, the LCD screen can display the value of rainfall capacity and turn on the green LED light. When the total rainfall is above the warning line, the LCD can display “Overflow” to warn the excessive rainfall and turn on the red LED automatedly. This demonstration can representatively illustrate the potential of the proposed all-liquid TENG in functioning as a self-powered sensors.

Embodiments of the subject invention provide a rainwater-based all-liquid TENG by investigating, documenting, and advantageously providing design variables of L-L CE in various L-L systems. With exploration of L-L CE mechanisms, embodiments can address the key issues in designing all-liquid TENG for different application scenario, including material selection and structure design. For example, if a rainwater-based all-liquid TENG is designed, as demonstrated in certain embodiments, HFE can be advantageously selected as one of the optimal materials. If seawater is collected instead, oleic acid can be advantageously selected as one of the feasible materials because its dominant mechanism, functional group dissociation, would be inhibited by the high salt concentration the least (FIG. 2e). In these two situations, water will obtain positive charges and the structure of the electrode is preferably designed to be non-contact. Therefore, current can be generated through electromagnetic induction, and the influence of the negatively charged OH⁻ adsorption at the L-L interface can be avoided. On the contrary, if the preferential adsorption of OH⁻ dominates or if water is negatively charged through functional group dissociation, electrodes that transfer charge through direct contact are advantageously selected.

With the optimized materials and structure, embodiments of the provided rainwater-based all-liquid TENG can generate a high charge density (3.63 μC/L) and a direct current with high output stability (crest factor 1.1). Embodiments provide a paradigm to harvest energy from nature through L-L CE, making possible the development of improved all-liquid systems in green energy. Embodiments can also be dispersed and placed in rainfall-prone areas to realize a distributed energy network for direct-to-consumer energy supply. Based on the demonstration of the proposed all-liquid TENG as a rainfall alarming system, the sensitive response of the electrical output to various parameters can further extend its application in passive sensors, offering advantages over traditional solid material-based electronic devices.

### Materials and Methods

In the following embodiments and examples, oleic acid (Sigma-Aldrich), hexadecane (Macklin), and HFE 7500 (Fluorochem) were selected as experimental objects for studying L-L CE. NaCl (Sigma-Aldrich) and HCl (Aladdin) were added to O/W emulsions in ζ-potential experiments. Deionized water with a resistivity of 18.3MΩcm was obtained from a water purification system (Direct-Q 5 UV-R, Merck).

To prepare samples of oil layer and water layer for charge measurements, DI water, and HFE/oleic acid/hexadecane with volume ratio of 1:1 was firstly mixed by shaking vertically 25 times. The mixture was then fixed on the spin coater (650 series, Laurell), rotating with the speed of 700 rpm (accelerated from 0 rpm with 100 rpm/s) for 70 seconds to separate two immiscible layers and produce friction between them (FIG. 6(a)). In both emulsion formation and rotating centrifugation process, relative movement between two liquids leads to L-L CE. Photos of the separated oil layer and water layer under a microscope showed that the separation is thorough, and water (oil) droplets seldomly remained in the oil (water) layer (FIG. 6(b)). As for the control group of pure DI water and pure HFE/oleic acid/hexadecane, the same procedures were repeated to eliminate the effect of contact electrification between samples and glass bottles.

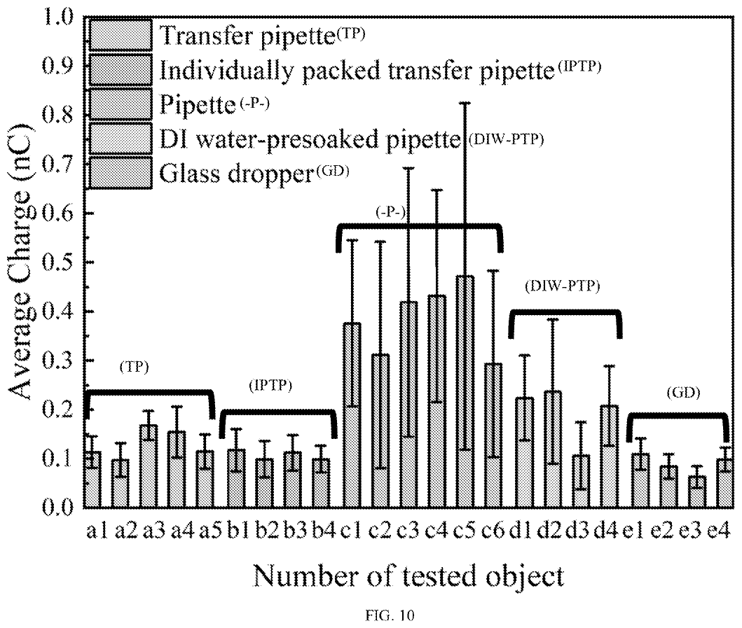

For the process of charge measurements for oil/water layers, a Faraday cup was fabricated with aluminum foil (18 μm-thick, Diamond) and connected with the programmable electrometer (6514, Keithley Instruments model) under the charge measurement model [58]. To measure the charge of liquid samples, samples were placed within the inside cup and an induced charge would flow into the electrometer while any atmospheric or stray electric fields can be shielded. By measuring charges of DI water samples with droppers made of different materials, glass droppers were found to cause the least, as well as the most stable amount of solid-liquid contact electrification to samples (FIG. 10). Therefore, glass droppers were used to extract liquid samples and to add them into the Faraday cup for charge measurement. To quantify the amount of transferred charge, the charge of control groups needed to be measured at first, and then subtracted from the charge of corresponding oil/water layer samples (FIG. 6c). In this way, the original charge and additional charge brought by contact electrification between sample and droppers can be eliminated.

To provide an embodiment for outdoor demonstration, the rainwater-based all-liquid TENG system was comprised of a reservoir for collecting rainwater and a main body of all-liquid TENG for generating current, as shown in FIG. 5c. These two parts are made of 3D printed transparent resin, connected by a micro tubing with a diameter of 0.034″ I.D.×0.052″ O.D. (LDPE, Scientific Commodities). The electrode was made of aluminum foil (18 μm-thick, Diamond) and placed inside of the main body, connected with the electrometer. As for all the experiments which need quantitative analysis, a commercial pump (LSP01-3A, Longer Pump) was used instead of the reservoir for better control, and the main body of all-liquid TENG was covered with a grounded Faraday cage to eliminate the influence from the external environment [23, 49]. In the quantitative experiments, the electrode has a diameter of 2.2 cm and a height of 2 cm and was placed on the axial line of the water outlet while their distance was maintained as 2.7 cm for most of the experiments according to the previous analysis and optimizations.

Simulation of the water droplet passing through the electrode ring was conducted using finite element analysis tools (COMSOL). Several simplifications were made during modeling. The shapes of the system were abstracted to combinations of perfect geometry primitives, with the dimensions measured in the experiments. The droplet was set uniformly charged with a positive charge. The surface of the electrode ring was set as floating potential boundaries. The oil environment was modeled as a cubic shape with a dimension greatly larger than the ring and wires, and all the surface boundaries were set grounded. The electrostatic interactions in the system were considered dominating, thus other physical phenomena were ignored in the simulation. By studying the electric field and the surface charge density on the electrode ring steadily at different droplet positions, the short-circuit current was calculated from the derivative of the surface charge on the electrode in a certain period.

For calculation for the ratio of transferred charges in L-L CE, a short-circuit current I_{SC} is composed of I₀ (produced by droplet generation) and ΔI (produced by droplet movement). Based on the analysis in Example S5, we can set I₀=k₀q₀ (where q₀ is the charge of the droplet at the end of its generation process) and ΔI_{PEAK}=k₁(q₀=δq) (where ΔIₚₑₐₖ is the peak value of ΔI and δq is the extra charges obtained from L-L CE). The peak value of the unified current can be described as:

$$\frac{Δ {I}_{PEAK}}{{I}_{0}} = \frac{{k}_{1} ( {q}_{0} + δ q )}{{k}_{0} {q}_{0}} = k ( 1 + \frac{δ q}{{q}_{0}} ) \qquad ( 4 )$$

Since one bottle of oil can be triboelectric-saturated eventually, δq→0 and

$$\frac{Δ {I}_{PEAK}}{{I}_{0}} \to k$$

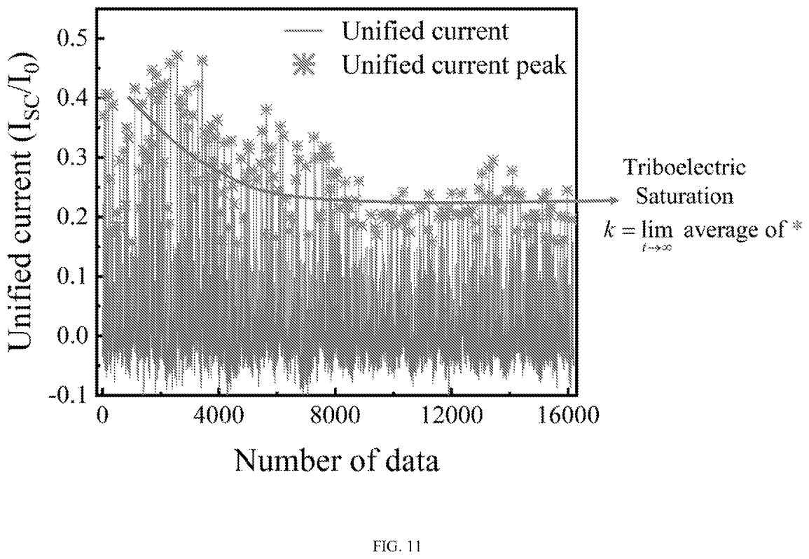

can be satisfied in one test. Therefore, we can obtain k from the unified current (FIG. 11).

After k is obtained:

$$\frac{\frac{Δ {I}_{P E A K}}{{I}_{0}}}{k} - 1 = \frac{δ q}{{q}_{0}} \qquad ( 5 )$$

Therefore,

$$\frac{δ q}{{q}_{0}}$$

can be obtained from the original experimental data of I_{SC}, quantifying the ratio of transferred charges in L-L CE to the original charge of water droplet.

Considering this charge transfer process between the refreshing water droplet and constant volume of oil can be analogized as the discharging process of a capacitor, ExpDecay fitting can be used to depict the changing rule of transferred charges in L-L CE:

$$y = {y}_{0} + {A}_{1} {e}^{- ( x - {x}_{0} ) / {t}_{1}} \qquad ( 6 )$$

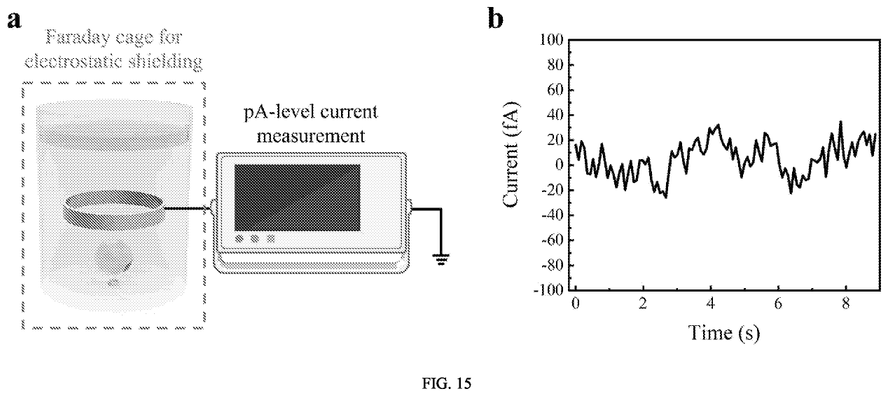

For experimental measurement, the programmable electrometer (6514, Keithley Instruments model) was used to measure the charge of samples, the short circuit current, and the open-circuit voltage of all-liquid TENG. To reduce the electromagnetic influence of the external environment, a Faraday cage made of copper was connected to the ground and placed at the outside of the experimental setup. By applying the electrostatic shielding and setting the current measurement range around pA-level, the 6514 electrometer can achieve an accuracy of ±1% rdg. according to its instruction manual, while the practical measured current noise of the electrometer 6514 has magnitude around fA-level, satisfying the requirements for pA-level current measurement (FIG. 15). PH meter (pH 550, Oakton) was used to measure the pH value of emulsions. Zetasizer (Zetasizer pro, Malvern Panalytical) with Folded capillary cells (DTS1070, Malvern Panalytical) was used to measure the ζ-potential of emulsions.

For statistical analysis, raw data was analyzed as recorded without pre-processing. To measure the charge variation for different all-liquid TENG systems, as shown in FIG. 2(b), at least three bottles of oil-water mixtures are prepared for each all-liquid TENG system (FIG. 6A), while at least twenty samples were extracted from each bottle for charge measurements to obtain the mean value of each bottle, which appears as one dot in FIG. 2(b). The mean and standard deviation of all samples from different bottles for each all-liquid TENG system appears as the bar and error bar in FIG. 2(b). To measure the pH variation for different all-liquid TENG systems, as shown in FIG. 2c, at least four O/W emulsion samples were prepared for each all-liquid TENG system, while each sample was measured at least twenty times to obtain the mean value of each sample, which appears as one dot in FIG. 2(c). The mean and standard deviation of all test results for different samples appears as the bar and error bar in FIG. 2(c). The measured pH variation was presented as mean±standard deviation. All statistical data were analyzed using Microsoft Excel.

All patents, patent applications, provisional applications, and publications referred to or cited herein are incorporated by reference in their entirety, including all figures and tables, to the extent they are not inconsistent with the explicit teachings of this specification.

Following are examples that illustrate procedures for practicing the invention. These examples should not be construed as limiting. All percentages are by weight and all solvent mixture proportions are by volume unless otherwise noted.

### Example S1

To compare the contribution of preferential adsorption of OH⁻ and carboxyl group dissociation to charge/pH measurement results, we consider experimental results of hexadecane-water and oleic acid-water systems as benchmarks respectively. When preferential adsorption of OH⁻ dominates in the system (hexadecane-water system), there's almost no charge transfer between two liquid phases (FIG. 2b) and the difference of pH value between DI water and O/W emulsion is about 0.03 (FIG. 2c). When carboxyl group dissociation dominates in the system (oleic acid-water system), charge transfer between two liquid phases is about 25 μC per 0.8 ml sample (FIG. 2b) and the difference of pH value between DI water and O/W emulsion is about 2.3 (FIG. 2c), which is much larger than the result of hexadecane-water system. Therefore, even if preferential adsorption of OH⁻ and carboxyl group dissociation exist simultaneously in oleic acid-water system, the trivial contribution of OH⁻ adsorption is neglected and its existence can be undetectable in previous charge/pH measurement.

### Example S2

A COMSOL simulation is performed to verify the correctness of Eq. (1). To be more realistic, the point charge in FIG. 3a is replaced with a uniformly positive charged perfect sphere in the simulation model (FIG. 3b). I_{SC} caused by droplet movement is obtained from the simulation result, which is compared with that calculated by Eq. (1) in FIG. 3c. Both results are composed of a positive peak and a following negative peak with different full widths at half maximum, which can be caused by the volume effect of the water droplet model. However, same ΔIₚₑₐₖ (peak value of the positive peak of I_{SC}) is obtained from both methods, indicating a reliable ΔIₚₑₐₖ can be obtained from Eq. (1) and used for calculating the ratio of transferred charges in L-L CE to the original charge of water droplet during all-liquid TENG's working process.

### Example S3

The capacitance of C₁ and C₂ formed between reference electrode, water droplet, and primary electrode (FIG. 4e), respectively, can be written as:

$$C = ε A / d \qquad ( S 1 )$$

where ε is electric constant of the dielectric, A is the effective area of plates and d is the distance between two plates.

In the droplet generation process, changes of all the parameters mentioned above can be neglected. Therefore, C₁ and C₂ remains as constants approximately. In the droplet movement process, the distance between the rising droplet and electrode ring decreases first and then increases, leading to the opposite variation trend of C₂. And the variation of C₁ can be neglected since the reference electrode is ground, which can be regarded as located at the infinitely far end.

### Example S4

In certain embodiments of the designed all-liquid TENG, rainwater is collected in the reservoir, and the water droplet is formed at the bottom of the oil phase due to the hydrostatic pressure difference. To produce water droplets continuously, h₁ (height difference between the water level in the reservoir and water outlet in oil phase) and h₂ (height difference between the oil level in the all-liquid TENG and water outlet in oil phase) can satisfy the following condition:

$${ρ}_{o i l} {h}_{2} \leq {ρ}_{water} {h}_{1} \qquad ( S 2 )$$

When the equality holds in Eq. (S2), no water droplets will be formed in all-liquid TENG and the system is in equilibrium.

### Example S5

Current caused by droplet generation is referred to as I₀ in the following discussion. In Eq. (1), the position of the water droplet z=z₀+r, so z₁−z=(z₁−z₀)−r, where z₁−z₀ is the distance between the water outlet and electrode ring and r is the radius of the droplet during its generation process, and we have 1-0>> according to actual parameters. Therefore, r can be negligible in calculation of Eq. (1). When r is neglected in Eq. (1), we have

$${I}_{0} ∝ \frac{d {q}_{d}}{d t} ,$$

where q_{d} is the real-time charge of the water droplet. When the flow rate is constant,

$$\frac{d {q}_{d}}{d t}$$

can be approximated as constant, and we have

$${I}_{0} ∝ {q}_{0} = {t}_{generation} \cdot \frac{d {q}_{d}}{d t} ,$$

where 0 is the charge of the droplet at the end of its generation process.

Current caused by droplet movement is referred to as in the following discussion. The real-time charge of the water droplet can be written as q_{d}=q₀+δq(t), where 0 is the charge of the droplet at the end of its generation process, δq(t) is the real-time extra charges obtained from L-L CE. The position of the water droplet can be written as

$$z = {z}_{g} + \frac{1}{2} a {t}^{2} ,$$

where z_{g} is the position of the droplet center at the end of its generation process and

$$a = \frac{( {ρ}_{o i l} - {ρ}_{water} ) \frac{4}{3} {ρ}_{water} π {r}^{3} g}{6 πη rt + \frac{4}{3} {ρ}_{water} π {r}^{3}} .$$

After substituting these actual parameters into Eq. (1), can be written as

$$Δ I = \frac{d {q}_{d}}{2 d t} \cdot {1}_{s t} item + \frac{{q}_{d}}{2} \cdot {2}_{n d} item ,$$

$$where$$

$$\frac{{2}_{nd} item ' s contribution for Δ {I}_{peak} ( the peak value of Δ I )}{{1}_{nd} item ' s contribution for Δ {I}_{peak} ( the peak value of Δ I )} > 28.$$

Therefore, ΔIₚₑₐₖ can be approximated as ΔIₚₑₐₖ∝q_{d}=q₀+δq, where 0 is the charge of the droplet at the end of its generation process and Sq is the extra charges obtained from L-L CE.

### EXEMPLIFIED EMBODIMENTS

The invention may be better understood by reference to certain illustrative examples, including but not limited to the following:

Embodiment 1. A liquid-liquid (L-L) contact electrification (CE) triboelectric nanogenerator (TENG) system for producing power in a self-powered sensor, the system comprising:
a first fluid volume comprising purified water or an aqueous solution;
wherein the purified water or aqueous solution can be water obtained from nature for green power generation, including rainwater, sea water, moisture captured from air, or other natural sources. The purified water or aqueous solution can also be water or aqueous solution that has been used in other applications (e.g., in a microfluidics platform) to recycle or achieve secondary usage of water resources and supply energy for the original device;
wherein a lower the concentration of ions in the aqueous solution has been shown to improve performance of the TENG in some embodiments;
a second fluid volume comprising an oil, the oil having a density different than the density of the purified water or aqueous solution;
wherein the oil can be selected from suitable oils known in the art, or any suitable liquid that is immiscible with the first fluid volume, and wherein the first fluid volume can be electrically insulated from the second fluid volume;
wherein an oil with a lower density than the first fluid volume can be used in embodiments where the water outlet or droplet generator is located on top of the second fluid volume, configured and adapted to generate water droplets from the top of the oil bulk phase and let it sink due to gravity (e.g., see FIG. 13(b) for one such embodiment;)
wherein an oil with a higher density than the first fluid volume can be used in embodiments where the water outlet or droplet generator is located at the bottom of the second fluid volume, configured and adapted to generate water droplets from the bottom of the oil bulk phase and let each droplet rise due to buoyancy (e.g., see FIG. 13(a) for one such embodiment;)
a droplet generator fluidly connecting the first fluid volume and the second fluid volume;
an electrode having a positive terminal and a ground terminal, the ground terminal connected to ground or to a large mass of conductive material;
wherein the large mass of conductive material can be a mass equal to or about equal to ½ the mass of the TENG, alternatively equal to or about equal to the mass of the TENG, 1.5 times the mass of the TENG, twice the mass of the TENG, five times the mass of the TENG, ten times the mass of the TENG, or greater, including combinations, increments, and divisions thereof;
the positive terminal and the ground terminal having a direct connection to an electronic circuit comprising a capacitor in parallel with a load;
the electrode contained within the second fluid volume;
the electrode aligned above or below an outlet of the first fluid volume in the droplet generator;
the first fluid volume having a first height (h₁) above the droplet generator;
the second fluid volume having a second height (h₂) above the droplet generator;
the first fluid volume having a first density (ρ₁);
the second fluid volume having a second density (ρ₂);
the first fluid volume, the second fluid volume, and the droplet generator each respectively configured and adapted such that when the equation:

$${ρ}_{2} {h}_{2} < {ρ}_{1} {h}_{1}$$

is satisfied, a multiplicity of droplets of the aqueous solution are formed and released, each droplet, respectively, rising or falling through the second fluid volume proximate the electrode, driven by the force of gravity acting upon the first density and the second density, respectively; and
wherein passage of the multiplicity of droplets proximate the electrode generates a displacement current between the positive terminal and the ground terminal.

Embodiment 2. The system of Embodiment 1, the direct connection comprising a first switch (S₁) between the electrode and the electronic circuit and a second switch (S₂) between S₁ and the load.

Embodiment 3. The system of Embodiment 1, characterized by the absence of any rectifier between the electrode and the electronic circuit.

Embodiment 4. The system of Embodiment 1, exhibiting a charge density greater than or equal to about 1 μC/L, a CE time greater than or equal to about 500 seconds, and an output stability greater than or equal to about 0.7.

Embodiment 5. The system of Embodiment 4, exhibiting at least one of (i) a charge density greater than or equal to about 3.63 μC/L, or (ii) a CE time greater than or equal to about 1200 seconds, or (iii) an output stability greater than or equal to about 0.9.

Embodiment 6. The system of Embodiment 1, exhibiting (i) a charge density greater than or equal to about 3.63 μC/L, (ii) a CE time greater than or equal to about 1200 seconds, and (iii) an output stability greater than or equal to about 0.9. Wherein CE time is defined as the effective time for an oil frictional material to transfer electrons to water and positively charge it. Wherein the method to measure CE time is shown in FIG. 3(d). When the ratio of transferred charge approaches zero, it means this specific volume of oil is triboelectric saturated, and it cannot provide more electrons to charge the water droplet. And the time it takes before the ratio of transferred charges become zero (represented by the projecting of the slope of the upper bound curve fit for each data series in FIG. 3(d) out to the projected x-axis intercept point) is the effective CE time.

Embodiment 7. The system of Embodiment 1, wherein the first fluid volume comprises collected rainwater and the oil (optionally comprising a frictional oil material) is configured and adapted to positively charge the respective collected rainwater droplets through electron transfer and preferential ion adsorption. Wherein the frictional oil material used in some embodiments is an oil which has the required (optionally: improved, enhanced, or functionally sufficient) performance in charging a water droplet through contact electrification (also called triboelectrification).

Embodiment 8. The system of Embodiment 7, wherein the electrode is a ring-shaped electrode configured and adapted to generate displacement current through electrostatic induction.

Embodiment 9. The system of Embodiment 8, the contact distance being about 2.7 cm, the ring diameter being about 2.2 cm, and the ring height being about 2 cm.

Embodiment 10. The system of Embodiment 9, wherein the frictional oil material comprises hydrofluoroether (HFE). While not being bound by theory, in certain embodiments, HFE could be replaced by an alternative oil material which can positively charge a sufficient quantity of water droplets through electron transfer (e.g., an oil liquid that contains a fluorine element such as Perfluoropolyether (PFPE) would be expected to function suitably).

Embodiment 11. The system of Embodiment 1, wherein the first fluid volume comprises collected seawater and the oil comprises a frictional oil material configured and adapted to positively charge the respective collected seawater droplets through functional group dissociation and preferential ion adsorption.

Embodiment 12. The system of Embodiment 11, wherein the electrode is a ring-shaped electrode configured and adapted to generate displacement current through electrostatic induction.

Embodiment 13. The system of Embodiment 12, wherein the frictional oil material comprises oleic acid (OA). Wherein, in certain embodiments, OA could be replaced by any oil material which can positively charge a sufficient quantity of water droplet through functional group dissociation. While not being bound by theory, in certain embodiments oil liquids that contain a dissociated functional group (e.g., —COOH) are expected to function suitably.

Embodiment 14. The system of Embodiment 1, wherein the oil comprises a frictional oil material configured and adapted to negatively charge the respective droplets through functional group dissociation, electron transfer, or selective adsorption of negative ions at the oil-water interface.

Embodiment 15. The system of Embodiment 14, wherein the electrode is configured and adapted to generate displacement current through direct contact with the droplets.

Embodiment 16. The system of Embodiment 15, wherein the frictional oil material comprises hexadecane (Hex). Wherein in certain embodiments, Hex could be replaced by an oil material which can generate sufficient amounts of negatively charged ion adsorption at the oil-water interface. While not being bound by theory, the inventors hypothesize that many common oils will show good performance in certain embodiments (e.g., dodecane).

Embodiment 17. A method for producing power in a self-powered sensor using a liquid-liquid (L-L) contact electrification (CE) triboelectric nanogenerator (TENG) system, the method comprising:
providing a first fluid volume comprising purified water or an aqueous solution, the first fluid volume having a first density;
providing a second fluid volume comprising an oil, the second fluid volume having a second density different than the first density;
providing an electrode having a positive terminal and a ground terminal,
   the positive terminal and the ground terminal having a direct connection to an electronic circuit comprising a capacitor in parallel with a load,
   the electrode contained within the second fluid volume,
   the electrode aligned vertically either above or below the droplet generator;
providing a droplet generator in fluid contact with the first fluid volume and the second fluid volume;
the first fluid volume having a first height (h₁) above the droplet generator;
the second fluid volume having a second height (h₂) above the droplet generator;
the first density having a value (ρ₁);
the second density having a value (ρ₂);
the first fluid volume, the second fluid volume, and the droplet generator each respectively configured and adapted such that when the equation:

$${ρ}_{2} {h}_{2} < {ρ}_{1} {h}_{1}$$

is satisfied, a multiplicity of droplets of the aqueous solution are formed and released, each droplet, respectively, either rising or falling through the second fluid volume proximate the electrode, driven by the force of gravity acting upon the first density and the second density, respectively;
wherein passage of the multiplicity of droplets proximate the electrode generates a displacement current between the positive terminal and the ground terminal;
wherein the direct connection comprises a first switch (S₁) between the electrode and the electronic circuit and a second switch (S₂) between S₁ and the load;
wherein the circuit is characterized by the absence of any rectifier.

Embodiment 18. The method of Embodiment 17, wherein the TENG exhibits (i) a charge density greater than or equal to about 3.63 μC/L, (ii) a CE time greater than or equal to about 1200 seconds, and (iii) an output stability greater than or equal to about 0.9;
wherein the first fluid volume comprises collected rainwater and the oil comprises hydrofluoroether (HFE) and is configured and adapted to positively charge the respective collected rainwater droplets through electron transfer and preferential ion adsorption;
wherein the electrode is a ring-shaped electrode configured and adapted to generate displacement current through electrostatic induction.

Embodiment 19. A liquid-liquid (L-L) contact electrification (CE) triboelectric nanogenerator (TENG) system for producing power in a self-powered sensor, the system comprising:
a first fluid volume comprising purified water or an aqueous solution;
a second fluid volume comprising an oil, the oil having a density different from or greater than the density of the purified water or aqueous solution;
a droplet generator fluidly connecting the first fluid volume and the second fluid volume;
an electrode having a positive terminal and a ground;
the positive terminal and the ground having a direct connection to an electronic circuit comprising a capacitor in parallel with a load;
the electrode contained within the second fluid volume;
the electrode aligned above the droplet generator;
the first fluid volume having a first height (h₁) above the droplet generator;
the second fluid volume having a second height (h₂) above the droplet generator;
the first fluid volume having a first density (ρ₁);
the second fluid volume having a second density (ρ₂);
the first fluid volume, the second fluid volume, and the droplet generator each respectively configured and adapted such that when the equation:

$${ρ}_{2} {h}_{2} < {ρ}_{1} {h}_{1}$$

is satisfied, a multiplicity of droplets of the aqueous solution are formed and released, each droplet, respectively, rising up through the second fluid volume proximate the electrode;
wherein passage of the multiplicity of droplets proximate the electrode generates a displacement current between the positive terminal and the ground;
wherein the direct connection comprises a first switch (S₁) between the electrode and the electronic circuit and a second switch (S₂) between S₁ and the load;
wherein the system is characterized by the absence of any rectifier between the electrode and the electronic circuit;
wherein the system exhibits (i) a charge density greater than or equal to about 3.63 μC/L, (ii) a CE time greater than or equal to about 1200 seconds, and (iii) an output stability greater than or equal to about 0.9;
wherein the first fluid volume comprises rainwater and the oil comprises hydrofluoroether (HFE) and is configured and adapted to positively charge the respective rainwater droplets through electron transfer and preferential ion adsorption;
wherein the electrode is a ring-shaped electrode configured and adapted to generate displacement current through electrostatic induction; and
wherein the load comprises a rainfall alarming system, configured and adapted to monitor a total rainfall based on a voltage between the positive terminal and the ground, to display the total rainfall on an LCD screen when the voltage is beneath a warning line, and to warn of excessive rainfall when the voltage is above the warning line.

Embodiment 20. The system of Embodiment 19, wherein the ring-shaped electrode has a contact distance above the droplet generator, a ring diameter, and a ring height, the contact distance being about 2.7 cm, the ring diameter being about 2.2 cm, and the ring height being about 2 cm.

Embodiment 21. A liquid-liquid (L-L) contact electrification (CE) triboelectric nanogenerator (TENG) system for producing power in a self-powered sensor, the system comprising:
a first fluid volume comprising purified water or an aqueous solution;
a second fluid volume comprising an oil, the oil having a density different than the density of the purified water or aqueous solution;
a droplet generator fluidly connecting the first fluid volume and the second fluid volume;
an electrode having a positive terminal and a ground terminal, the ground terminal connected to ground or to a conductive material having a mass greater than the mass of the TENG;
the positive terminal and the ground terminal having a direct connection to an electronic circuit comprising a capacitor in parallel with a load;
the electrode contained within the second fluid volume;
the electrode aligned above or below the droplet generator;
the first fluid volume having a first height (h₁) above the droplet generator;
the second fluid volume having a second height (h₂) above the droplet generator;
the first fluid volume having a first density (ρ₁);
the second fluid volume having a second density (ρ₂);
the first fluid volume, the second fluid volume, and the droplet generator each respectively configured and adapted such that when the equation:

$${ρ}_{2} {h}_{2} < {ρ}_{1} {h}_{1}$$

is satisfied, a multiplicity of droplets of the aqueous solution are formed and released, each droplet, respectively, passing through the second fluid volume proximate the electrode, driven by the force of gravity acting upon the first density and the second density, respectively; and
wherein passage of the multiplicity of droplets proximate the electrode generates a displacement current between the positive terminal and the ground terminal.

Embodiment 22. The system of Embodiment 21, the direct connection comprising a first switch (S₁) between the electrode and the electronic circuit and a second switch (S₂) between S₁ and the load.

Embodiment 23. The system of Embodiment 21, characterized by the absence of any rectifier between the electrode and the electronic circuit.

Embodiment 24. The system of Embodiment 21, exhibiting a charge density greater than or equal to about 1 μC/L, a CE time greater than or equal to about 500 seconds, and an output stability greater than or equal to about 0.7.

Embodiment 25. The system of Embodiment 24, exhibiting at least one of (i) a charge density greater than or equal to about 3.63 μC/L, or (ii) a CE time greater than or equal to about 1200 seconds, or (iii) an output stability greater than or equal to about 0.9.

Embodiment 26. The system of any of Embodiments 21-23, exhibiting (i) a charge density greater than or equal to about 3.63 μC/L, (ii) a CE time greater than or equal to about 1200 seconds, and (iii) an output stability greater than or equal to about 0.9.

Embodiment 27. The system of any of Embodiments 21-25, wherein the first fluid volume comprises rainwater and the oil comprises a frictional oil material configured and adapted to positively charge the respective rainwater droplets through electron transfer and preferential ion adsorption.

Embodiment 28. The system of Embodiment 27, wherein the electrode is a ring-shaped electrode configured and adapted to generate displacement current through electrostatic induction.

Embodiment 29. The system of Embodiment 28, the contact distance being about 2.7 cm, the ring diameter being about 2.2 cm, and the ring height being about 2 cm.

Embodiment 30. The system of claim Embodiment 29, wherein the frictional oil material comprises hydrofluoroether (HFE).

Embodiment 31. The system of any of Embodiments 21-25, wherein the first fluid volume comprises seawater and the oil comprises a frictional oil material configured and adapted to positively charge the respective seawater droplets through functional group dissociation and preferential ion adsorption.

Embodiment 32. The system of Embodiment 31, wherein the electrode is a ring-shaped electrode configured and adapted to generate displacement current through electrostatic induction.

Embodiment 33. The system of Embodiment 32, wherein the frictional oil material comprises oleic acid (OA).

Embodiment 34. The system of any of Embodiments 21-25, wherein the oil comprises a frictional oil material configured and adapted to negatively charge the respective droplets through functional group dissociation, electron transfer, or selective adsorption of negative ions at the oil-water interface; and wherein the electrode is configured and adapted to generate displacement current through direct contact with the droplets.

Embodiment 35. The system of Embodiment 34, wherein the frictional oil material comprises hexadecane (Hex).

Embodiment 36. A method for producing power in a self-powered sensor using a liquid-liquid (L-L) contact electrification (CE) triboelectric nanogenerator (TENG) system, the method comprising:
providing a first fluid volume comprising purified water or an aqueous solution, the first fluid volume having a first density;
providing a second fluid volume comprising an oil, the second fluid volume having a second density different than the first density;
providing an electrode having a positive terminal and a ground terminal,
   the positive terminal and the ground terminal having a direct connection to an electronic circuit comprising a capacitor in parallel with a load,
   the electrode contained within the second fluid volume,
   the electrode aligned vertically either above or below the droplet generator;
providing a droplet generator in fluid contact with the first fluid volume and the second fluid volume;
the first fluid volume having a first height (h₁) above the droplet generator;
the second fluid volume having a second height (h₂) above the droplet generator;
the first density having a value (ρ₁);
the second density having a value (ρ₂);
the first fluid volume, the second fluid volume, and the droplet generator each respectively configured and adapted such that when the equation:

$${ρ}_{2} {h}_{2} < {ρ}_{1} {h}_{1}$$

is satisfied, a multiplicity of droplets of the aqueous solution are formed and released, each droplet, respectively, passing through the second fluid volume proximate the electrode, driven by the force of gravity acting upon the first density and the second density, respectively;
wherein passage of the multiplicity of droplets proximate the electrode generates a displacement current between the positive terminal and the ground terminal;
wherein the direct connection comprises a first switch (S₁) between the electrode and the electronic circuit and a second switch (S₂) between S₁ and the load;
wherein the circuit is characterized by the absence of any rectifier.

Embodiment 37. The method of Embodiment 36, wherein the TENG exhibits (i) a charge density greater than or equal to about 3.63 μC/L, (ii) a CE time greater than or equal to about 1200 seconds, and (iii) an output stability greater than or equal to about 0.9;
wherein the first fluid volume comprises rainwater and the oil comprises hydrofluoroether (HFE) and is configured and adapted to positively charge the respective rainwater droplets through electron transfer and preferential ion adsorption;
wherein the electrode is a ring-shaped electrode configured and adapted to generate displacement current through electrostatic induction.

Embodiment 38. A liquid-liquid (L-L) contact electrification (CE) triboelectric nanogenerator (TENG) system for producing power in a self-powered sensor, the system comprising:
a first fluid volume comprising purified water or an aqueous solution;
a second fluid volume comprising an oil, the oil having a density different than the density of the purified water or aqueous solution;
a droplet generator fluidly connecting the first fluid volume and the second fluid volume;
an electrode having a positive terminal and a ground terminal, the ground terminal connected to ground or to a conductive material having a mass greater than the mass of the TENG;
the positive terminal and the ground terminal having a direct connection to an electronic circuit comprising a capacitor in parallel with a load;
the electrode contained within the second fluid volume;
the electrode aligned above or below the droplet generator;
the first fluid volume having a first height (h₁) above the droplet generator;
the second fluid volume having a second height (h₂) above the droplet generator;
the first fluid volume having a first density (ρ₁);
the second fluid volume having a second density (ρ₂);
the first fluid volume, the second fluid volume, and the droplet generator each respectively configured and adapted such that when the equation:

$${ρ}_{2} {h}_{2} < {ρ}_{1} {h}_{1}$$

is satisfied, a multiplicity of droplets of the aqueous solution are formed and released, each droplet, respectively, passing through the second fluid volume proximate the electrode;
wherein passage of the multiplicity of droplets proximate the electrode generates a displacement current between the positive terminal and the ground terminal;
wherein the direct connection comprises a first switch (S₁) between the electrode and the electronic circuit and a second switch (S₂) between S₁ and the load;
wherein the system is characterized by the absence of any rectifier between the electrode and the electronic circuit;
wherein the system exhibits (i) a charge density greater than or equal to about 3.63 μC/L, (ii) a CE time greater than or equal to about 1200 seconds, and (iii) an output stability greater than or equal to about 0.9.

Embodiment 39. The system of Embodiment 38, wherein the first fluid volume comprises rainwater, the oil comprises hydrofluoroether (HFE), and the oil is configured and adapted to positively charge the respective rainwater droplets through electron transfer and preferential ion adsorption;
wherein the first fluid volume, the second fluid volume, and the droplet generator are each respectively configured and adapted such that when the equation:

$${ρ}_{2} {h}_{2} < {ρ}_{1} {h}_{1}$$

is satisfied, a multiplicity of droplets of the aqueous solution are formed and released, each droplet, respectively, rising up through the second fluid volume proximate the electrode;
wherein the electrode is a ring-shaped electrode aligned above the droplet generator, the electrode configured and adapted to generate displacement current through electrostatic induction; and
wherein the load comprises a rainfall monitoring system, configured and adapted to monitor a respective rainfall amount based on a voltage between the positive terminal and the ground.

Embodiment 40. The system of Embodiment 38, wherein the first fluid volume comprises rainwater, the oil comprises oleic acid (OA) or hexadecane (Hex) or both, and the oil is configured and adapted to charge the respective rainwater droplets through functional group dissociation and/or preferential ion adsorption;
wherein the first fluid volume, the second fluid volume, and the droplet generator are each respectively configured and adapted such that when the equation:

$${ρ}_{2} {h}_{2} < {ρ}_{1} {h}_{1}$$

is satisfied, a multiplicity of droplets of the aqueous solution are formed and released, each droplet, respectively, dropping down through the second fluid volume proximate the electrode;
wherein the electrode is a ring-shaped electrode aligned below the droplet generator, the electrode configured and adapted to generate displacement current through electrostatic induction; and
wherein the load comprises a rainfall monitoring system, configured and adapted to monitor a respective rainfall amount based on a voltage between the positive terminal and the ground.

Although the present invention has been illustrated and described herein with reference to preferred embodiments and specific examples thereof, it will be readily apparent to those of ordinary skill in the art that other embodiments and examples may perform similar functions and/or achieve like results.

When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

When ranges are used herein, combinations and subcombinations of ranges (e.g., subranges within the disclosed range), specific embodiments therein are intended to be explicitly included.

The transitional term “comprising,” “comprises,” or “comprise” is inclusive or open-ended and does not exclude additional, unrecited elements or method steps. By contrast, the transitional phrase “consisting of” excludes any element, step, or ingredient not specified in the claim. The phrases “consisting” or “consists essentially of” indicate that the claim encompasses embodiments containing the specified materials or steps and those that do not materially affect the basic and novel characteristic(s) of the claim. Use of the term “comprising” contemplates other embodiments that “consist” or “consisting essentially of” the recited component(s).

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

### REFERENCES

1. Wang, Z. L. and J. Song, Piezoelectric nanogenerators based on zinc oxide nanowire arrays. Science, 2006. 312(5771): p. 242-246.
2. Zhang, Z., et al., Emerging hydrovoltaic technology. Nature Nanotechnology, 2018. 13(12): p. 1109-1119.
3. Bell, L. E., Cooling, heating, generating power, and recovering waste heat with thermoelectric systems. Science, 2008. 321(5895): p. 1457-1461.
4. Rancourt, D., A. Tabesh, and L. G. Fréchette, Evaluation of centimeter-scale micro windmills: aerodynamics and electromagnetic power generation. Proc. PowerMEMS, 2007. 20079: p. 93-96.
5. Mishra, S., S. K. Singal, and D. K. Khatod, Optimal installation of small hydropower plant—A review. Renewable and Sustainable Energy Reviews, 2011. 15(8): p. 3862-3869.
6. Alanne, K. and A. Saari, Distributed energy generation and sustainable development. Renewable and Sustainable Energy Reviews, 2006. 10(6): p. 539-558.
7. Zhang, Q., et al., Highly efficient raindrop energy-based triboelectric nanogenerator for self-powered intelligent greenhouse. ACS nano, 2021. 15(7): p. 12314-12323.
8. Wang, Y., et al., An underwater flag-like triboelectric nanogenerator for harvesting ocean current energy under extremely low velocity condition. Nano Energy, 2021. 90: p. 106503.
9. Liu, D., et al., A constant current triboelectric nanogenerator arising from electrostatic breakdown. Science Advances, 2019. 5(4): p. eaav6437.
10. Wu, C., et al., Triboelectric Nanogenerator: A Foundation of the Energy for the New Era. Advanced Energy Materials, 2019. 9(1): p. 1802906.
11. Wang, Z. L., Triboelectric Nanogenerator (TENG)—Sparking an Energy and Sensor Revolution. Advanced Energy Materials, 2020. 10(17): p. 2000137.
12. Kim, W.-G., et al., Triboelectric Nanogenerator: Structure, Mechanism, and Applications. ACS Nano, 2021. 15(1): p. 258-287.
13. Wang, P., et al., Non-contact and liquid-liquid interfacing triboelectric nanogenerator for self-powered water/liquid level sensing. Nano Energy, 2020. 72: p. 104703.
14. Xu, W., et al., SLIPS-TENG: robust triboelectric nanogenerator with optical and charge transparency using a slippery interface. National Science Review, 2019. 6(3): p. 540-550.
15. Creux, P., et al., Strong Specific Hydroxide Ion Binding at the Pristine Oil/Water and Air/Water Interfaces. The Journal of Physical Chemistry B, 2009. 113(43): p. 14146-14150.
16. Beattie, J. K. and A. M. Djerdjev, The Pristine Oil/Water Interface: Surfactant-Free Hydroxide-Charged Emulsions. Angewandte Chemie International Edition, 2004. 43(27): p. 3568-3571.
17. Marinova, K. G., et al., Charging of Oil-Water Interfaces Due to Spontaneous Adsorption of Hydroxyl Ions. Langmuir, 1996. 12(8): p. 2045-2051.
18. Beattie, J. K., A. M. Djerdjev, and G. G. Warr, The surface of neat water is basic. Faraday discussions, 2009. 141: p. 31-39.
19. Stachurski, J. and M. MichaLek, The Effect of the ζ Potential on the Stability of a Non-Polar Oil-in-Water Emulsion. Journal of Colloid and Interface Science, 1996. 184(2): p. 433-436.
20. Silva, C. E. P., et al., Double stabilization mechanism of O/W Pickering emulsions using cationic nanofibrillated cellulose. Journal of Colloid and Interface Science, 2020. 574: p. 207-216.
21. Kurniawan, J., K. Suga, and T. L. Kuhl, Interaction forces and membrane charge tunability: Oleic acid containing membranes in different pH conditions. Biochimica et Biophysica Acta (BBA)—Biomembranes, 2017. 1859(2): p. 211-217.
22. Poli, E., K. H. Jong, and A. Hassanali, Charge transfer as a ubiquitous mechanism in determining the negative charge at hydrophobic interfaces. Nature Communications, 2020. 11(1): p. 901.
23. Zhao, X., et al., Studying of contact electrification and electron transfer at liquid-liquid interface. Nano Energy, 2021. 87: p. 106191.
24. Tang, Z., S. Lin, and Z. L. Wang, Quantifying Contact-Electrification Induced Charge Transfer on a Liquid Droplet after Contacting with a Liquid or Solid. Advanced Materials, 2021. 33(42): p. 2102886.
25. Pullanchery, S., et al., Charge transfer across C—H . . . O hydrogen bonds stabilizes oil droplets in water. Science, 2021. 374(6573): p. 1366-1370.
26. Nie, J., et al., Power generation from the interaction of a liquid droplet and a liquid membrane. Nature Communications, 2019. 10(1).
27. Fang, S., et al., An Efficient Piezoelectric Energy Harvesting Circuit With Series-SSHI Rectifier and FNOV-MPPT Control Technique. IEEE Transactions on Industrial Electronics, 2021. 68(8): p. 7146-7155.
28. Zangi, R. and J. B. F. N. Engberts, Physisorption of Hydroxide Ions from Aqueous Solution to a Hydrophobic Surface. Journal of the American Chemical Society, 2005. 127(7): p. 2272-2276.
29. Cheng, H. and D. A. Sabatini, Phase-behavior-based surfactant-contaminant separation of middle phase microemulsions. Separation Science and Technology, 2002. 37(1): p. 127-146.
30. Instruments, M., Zeta potential: An Introduction in 30 minutes. Zetasizer Nano Series Tech. Note. MRK654, 2011. 1(2): p. 1-6.
31. Brennan, W. J., et al., Contact electrification and surface composition. Journal of Physics D: Applied Physics, 1995. 28(11): p. 2349-2355.
32. Lin, S., et al., Effects of Surface Functional Groups on Electron Transfer at Liquid-Solid Interfacial Contact Electrification. ACS Nano, 2020. 14(8): p. 10733-10741.
33. Vu, D. L., et al., Enhancing the output performance of fluid-based triboelectric nanogenerator by using poly(vinylidene fluoride-co-hexafluoropropylene)/ionic liquid nanoporous membrane. International Journal of Energy Research, 2021. 45(6): p. 8960-8970.
34. Creux, P., et al., Specific Cation Effects at the Hydroxide-Charged Air/Water Interface. The Journal of Physical Chemistry C, 2007. 111(9): p. 3753-3755.
35. Franks, G. V., A. M. Djerdjev, and J. K. Beattie, Absence of Specific Cation or Anion Effects at Low Salt Concentrations on the Charge at the Oil/Water Interface. Langmuir, 2005. 21(19): p. 8670-8674.
36. Beattie, J. K., The intrinsic charge at the hydrophobe/water interface. Colloid Stability: The Role of Surface Forces, 2006: p. 153-164.
37. Drzymala, J., et al., Ice/Water Interface: Zeta Potential, Point of Zero Charge, and Hydrophobicity. Journal of Colloid and Interface Science, 1999. 220(2): p. 229-234.
38. Zimmermann, R., et al., Hydroxide and hydronium ion adsorption—A survey. Current Opinion in Colloid & Interface Science, 2010. 15(3): p. 196-202.
39. Ehtiati, K., et al., How Dissociation of Carboxylic Acid Groups in a Weak Polyelectrolyte Brush Depend on Their Distance from the Substrate. Langmuir, 2020. 36(9): p. 2339-2348.
40. Chen, R., A. B. McAllister, and M. Shen, Detection of zwitterion at an electrified liquid-liquid interface: A chemical equilibrium perspective. Journal of Electroanalytical Chemistry, 2020. 873: p. 114303.
41. Nap, R., P. Gong, and I. Szleifer, Weak polyelectrolytes tethered to surfaces: Effect of geometry, acid-base equilibrium and electrical permittivity. Journal of Polymer Science Part B: Polymer Physics, 2006. 44(18): p. 2638-2662.
42. Schweiss, R., et al., Dissociation of Surface Functional Groups and Preferential Adsorption of Ions on Self-Assembled Monolayers Assessed by Streaming Potential and Streaming Current Measurements. Langmuir, 2001. 17(14): p. 4304-4311.
43. Boroudjerdi, H., et al., Statics and dynamics of strongly charged soft matter. Physics Reports, 2005. 416(3): p. 129-199.
44. Lin, S., et al., Quantifying electron-transfer in liquid-solid contact electrification and the formation of electric double-layer. Nature Communications, 2020. 11(1): p. 399.
45. Nie, J., et al., Probing Contact-Electrification-Induced Electron and Ion Transfers at a Liquid-Solid Interface. Advanced Materials, 2020. 32(2): p. 1905696.
46. Lin, S., X. Chen, and Z. L. Wang, Contact Electrification at the Liquid-Solid Interface. Chemical Reviews, 2021.
47. Liljestrand, H. M., Average rainwater pH, concepts of atmospheric acidity, and buffering in open systems. Atmospheric Environment (1967), 1985. 19(3): p. 487-499.
48. Shammas, N. K., L. K. Wang, and M.-H. S. Wang, Sources, Chemistry and Control of Acid Rain in the Environment, in Handbook of Environment and Waste Management. p. 1-26.
49. Lüttgens, S., et al., Electrostatic Charge Measurements of Droplets of Various Liquids Falling over a Large Distance. Chemical Engineering & Technology, 2015. 38(7): p. 1261-1268.
50. Xi, F., et al., Universal power management strategy for triboelectric nanogenerator. Nano Energy, 2017. 37: p. 168-176.
51. Zhang, C., et al., Rotating-disk-based direct-current triboelectric nanogenerator. Advanced Energy Materials, 2014. 4(9): p. 1301798.
52. Ryu, H., et al., Sustainable direct current powering a triboelectric nanogenerator via a novel asymmetrical design. Energy & Environmental Science, 2018. 11(8): p. 2057-2063.
53. Song, Y., et al., Direct Current Triboelectric Nanogenerators. Advanced Energy Materials, 2020. 10(45): p. 2002756.
54. Liu, D., et al., Triboelectric nanogenerator: from alternating current to direct current. iScience, 2021. 24(1): p. 102018.
55. Chen, C., et al., Direct Current Fabric Triboelectric Nanogenerator for Biomotion Energy Harvesting. ACS Nano, 2020. 14(4): p. 4585-4594.
56. Niu, S., et al., Theoretical Investigation and Structural Optimization of Single-Electrode Triboelectric Nanogenerators. Advanced Functional Materials, 2014. 24(22): p. 3332-3340.
57. Shao, J., T. Jiang, and Z. Wang, Theoretical foundations of triboelectric nanogenerators (TENGs). Science China Technological Sciences, 2020. 63: p. 1087-1109.
58. Instruments, K., Low Level Measurements Handbook. Precision DC Current, Voltage and Resistance Measurements, 7th ed.; Keithley Instruments Inc.: Cleveland, OH, USA, 2013: p. 245.
59. Zhang, H., et al., Theories for triboelectric nanogenerators: A comprehensive review. Nanotechnology Reviews, 2020. 9(1): p. 610-625.

1. A liquid-liquid (L-L) contact electrification (CE) triboelectric nanogenerator (TENG) system for producing power in a self-powered sensor, the system comprising:
a first fluid volume comprising purified water or an aqueous solution;
a second fluid volume comprising an oil, the oil having a density different than the density of the purified water or aqueous solution;
a droplet generator fluidly connecting the first fluid volume and the second fluid volume;
an electrode having a positive terminal and a ground terminal, the ground terminal connected to ground or to a conductive material having a mass greater than the mass of the TENG;
the positive terminal and the ground terminal having a direct connection to an electronic circuit comprising a capacitor in parallel with a load;
the electrode contained within the second fluid volume;
the electrode aligned above or below the droplet generator;
the first fluid volume having a first height (h₁) above the droplet generator;
the second fluid volume having a second height (h₂) above the droplet generator;
the first fluid volume having a first density (ρ₁);
the second fluid volume having a second density (ρ₂);
the first fluid volume, the second fluid volume, and the droplet generator each respectively configured and adapted such that when the equation:
$${ρ}_{2} {h}_{2} < {ρ}_{1} {h}_{1}$$
is satisfied, a multiplicity of droplets of the aqueous solution are formed and released, each droplet, respectively, passing through the second fluid volume proximate the electrode, driven by the force of gravity acting upon the first density and the second density, respectively; and
wherein passage of the multiplicity of droplets proximate the electrode generates a displacement current between the positive terminal and the ground terminal.

2. The system of claim 1, the direct connection comprising a first switch (S₁) between the electrode and the electronic circuit and a second switch (S₂) between S₁ and the load.

3. The system of claim 1, characterized by the absence of any rectifier between the electrode and the electronic circuit.

4. The system of claim 1, exhibiting a charge density greater than or equal to about 1 μC/L, a CE time greater than or equal to about 500 seconds, and an output stability greater than or equal to about 0.7.

5. The system of claim 4, exhibiting at least one of (i) a charge density greater than or equal to about 3.63 μC/L, or (ii) a CE time greater than or equal to about 1200 seconds, or (iii) an output stability greater than or equal to about 0.9.

6. The system of claim 1, exhibiting (i) a charge density greater than or equal to about 3.63 μC/L, (ii) a CE time greater than or equal to about 1200 seconds, and (iii) an output stability greater than or equal to about 0.9.

7. The system of claim 1, wherein the first fluid volume comprises rainwater and the oil comprises a frictional oil material configured and adapted to positively charge the respective rainwater droplets through electron transfer and preferential ion adsorption.

8. The system of claim 7, wherein the electrode is a ring-shaped electrode configured and adapted to generate displacement current through electrostatic induction.

9. The system of claim 8, the contact distance being about 2.7 cm, the ring diameter being about 2.2 cm, and the ring height being about 2 cm.

10. The system of claim 9, wherein the frictional oil material comprises hydrofluoroether (HFE).

11. The system of claim 1, wherein the first fluid volume comprises seawater and the oil comprises a frictional oil material configured and adapted to positively charge the respective seawater droplets through functional group dissociation and preferential ion adsorption.

12. The system of claim 11, wherein the electrode is a ring-shaped electrode configured and adapted to generate displacement current through electrostatic induction.

13. The system of claim 12, wherein the frictional oil material comprises oleic acid (OA).

14. The system of claim 1, wherein the oil comprises a frictional oil material configured and adapted to negatively charge the respective droplets through functional group dissociation, electron transfer, or selective adsorption of negative ions at the oil-water interface; and wherein the electrode is configured and adapted to generate displacement current through direct contact with the droplets.

15. The system of claim 14, wherein the frictional oil material comprises hexadecane (Hex).

16. A method for producing power in a self-powered sensor using a liquid-liquid (L-L) contact electrification (CE) triboelectric nanogenerator (TENG) system, the method comprising:
providing a first fluid volume comprising purified water or an aqueous solution, the first fluid volume having a first density;
providing a second fluid volume comprising an oil, the second fluid volume having a second density different than the first density;
providing an electrode having a positive terminal and a ground terminal,
the positive terminal and the ground terminal having a direct connection to an electronic circuit comprising a capacitor in parallel with a load,
the electrode contained within the second fluid volume,
the electrode aligned vertically either above or below the droplet generator;
providing a droplet generator in fluid contact with the first fluid volume and the second fluid volume;
the first fluid volume having a first height (h₁) above the droplet generator;
the second fluid volume having a second height (h₂) above the droplet generator;
the first density having a value (ρ₁);
the second density having a value (ρ₂);
the first fluid volume, the second fluid volume, and the droplet generator each respectively configured and adapted such that when the equation:
$${ρ}_{2} {h}_{2} < {ρ}_{1} {h}_{1}$$
is satisfied, a multiplicity of droplets of the aqueous solution are formed and released, each droplet, respectively, passing through the second fluid volume proximate the electrode, driven by the force of gravity acting upon the first density and the second density, respectively;
wherein passage of the multiplicity of droplets proximate the electrode generates a displacement current between the positive terminal and the ground terminal;
wherein the direct connection comprises a first switch (S₁) between the electrode and the electronic circuit and a second switch (S₂) between S₁ and the load;
wherein the circuit is characterized by the absence of any rectifier.

17. The method of claim 16, wherein the TENG exhibits (i) a charge density greater than or equal to about 3.63 μC/L, (ii) a CE time greater than or equal to about 1200 seconds, and (iii) an output stability greater than or equal to about 0.9;
wherein the first fluid volume comprises rainwater and the oil comprises hydrofluoroether (HFE) and is configured and adapted to positively charge the respective rainwater droplets through electron transfer and preferential ion adsorption;
wherein the electrode is a ring-shaped electrode configured and adapted to generate displacement current through electrostatic induction.

18. A liquid-liquid (L-L) contact electrification (CE) triboelectric nanogenerator (TENG) system for producing power in a self-powered sensor, the system comprising:
a first fluid volume comprising purified water or an aqueous solution;
a second fluid volume comprising an oil, the oil having a density different than the density of the purified water or aqueous solution;
a droplet generator fluidly connecting the first fluid volume and the second fluid volume;
an electrode having a positive terminal and a ground terminal, the ground terminal connected to ground or to a conductive material having a mass greater than the mass of the TENG;
the positive terminal and the ground terminal having a direct connection to an electronic circuit comprising a capacitor in parallel with a load;
the electrode contained within the second fluid volume;
the electrode aligned above or below the droplet generator;
the first fluid volume having a first height (h₁) above the droplet generator;
the second fluid volume having a second height (h₂) above the droplet generator;
the first fluid volume having a first density (ρ₁);
the second fluid volume having a second density (ρ₂);
the first fluid volume, the second fluid volume, and the droplet generator each respectively configured and adapted such that when the equation:
$${ρ}_{2} {h}_{2} < {ρ}_{1} {h}_{1}$$
is satisfied, a multiplicity of droplets of the aqueous solution are formed and released, each droplet, respectively, passing through the second fluid volume proximate the electrode;
wherein passage of the multiplicity of droplets proximate the electrode generates a displacement current between the positive terminal and the ground terminal;
wherein the direct connection comprises a first switch (S₁) between the electrode and the electronic circuit and a second switch (S₂) between S₁ and the load;
wherein the system is characterized by the absence of any rectifier between the electrode and the electronic circuit;
wherein the system exhibits (i) a charge density greater than or equal to about 3.63 μC/L, (ii) a CE time greater than or equal to about 1200 seconds, and (iii) an output stability greater than or equal to about 0.9.

19. The system of claim 18, wherein the first fluid volume comprises rainwater, the oil comprises hydrofluoroether (HFE), and the oil is configured and adapted to positively charge the respective rainwater droplets through electron transfer and preferential ion adsorption;
wherein the first fluid volume, the second fluid volume, and the droplet generator are each respectively configured and adapted such that when the equation:
$${ρ}_{2} {h}_{2} < {ρ}_{1} {h}_{1}$$
is satisfied, a multiplicity of droplets of the aqueous solution are formed and released, each droplet, respectively, rising up through the second fluid volume proximate the electrode;
wherein the electrode is a ring-shaped electrode aligned above the droplet generator, the electrode configured and adapted to generate displacement current through electrostatic induction; and
wherein the load comprises a rainfall monitoring system, configured and adapted to monitor a respective rainfall amount based on a voltage between the positive terminal and the ground.

20. The system of claim 18, wherein the first fluid volume comprises rainwater, the oil comprises oleic acid (OA) or hexadecane (Hex) or both, and the oil is configured and adapted to charge the respective rainwater droplets through functional group dissociation and/or preferential ion adsorption;
wherein the first fluid volume, the second fluid volume, and the droplet generator are each respectively configured and adapted such that when the equation:
$${ρ}_{2} {h}_{2} < {ρ}_{1} {h}_{1}$$
is satisfied, a multiplicity of droplets of the aqueous solution are formed and released, each droplet, respectively, dropping down through the second fluid volume proximate the electrode;
wherein the electrode is a ring-shaped electrode aligned below the droplet generator, the electrode configured and adapted to generate displacement current through electrostatic induction; and
wherein the load comprises a rainfall monitoring system, configured and adapted to monitor a respective rainfall amount based on a voltage between the positive terminal and the ground.
